(19) United States
(12) Patent Application Publication
(10) Pub. No.: US 2003/0142946 A1
(43) Pub. Date: Jul. 31, 2003

(54) Optical module

(75) Inventors: Tsunetoshi Saito, Tokyo (JP); Junichi Hasegawa, Tokyo (JP); Kanji Tanaka, Tokyo (JP); Kazuhisa Kashihara, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: The Furukawa Electric Co. Ltd., Tokyo (JP)

(21) Appl. No.: 10/292,599

(22) Filed: Nov. 13, 2002

(30) Foreign Application Priority Data
Nov. 13, 2001 (JP) 2001-347796
Dec. 21, 2001 (JP) 2001-89848
Aug. 14, 2002 (JP) 2002-236569

(51) Int. Cl. G02B 6/00

(52) U.S. Cl. 385/137

(57) ABSTRACT

An optical fiber module of the invention is an optical fiber module easily fabricated and excellent in the characteristics of enduring high intensity light, for example. The connection end face of an optical fiber array as an optical component is faced to the connection end face of a planar lightwave circuit component. An optical fiber array is also disposed on the connection end face of the planar lightwave circuit component opposite to the optical fiber array. The corresponding connection end faces are connected to each other with an adhesive. A no adhesive filled part where the adhesive is not applied in the light transmitting area is disposed in at least one of bonding parts thereof.

### BACKGROUND OF THE INVENTION

1. Field of the Invention

The present invention relates to an optical fiber module.

2. Discussion of the Background

At present, the practical application of a planar lightwave circuit (PLC) component is proceeding in the field of optical communications. This planar lightwave circuit component is configured in which a planar lightwave circuit is formed on a silicon substrate or silica substrate, having advantages to realize low price and large scale integration. In addition, with the realization of forming the planar lightwave circuit component into a multi-function product, the large scale integration of the planar lightwave circuit to be arranged and upsizing of the planar lightwave circuit component are proceeding.

Generally, the planar lightwave circuit component is connected to an optical fiber array having optical fibers arranged, and then it is formed into a module. An optical fiber module having the planar lightwave circuit component and the optical fiber array formed into a module is a planar lightwave circuit module. As shown in FIG. 27, for example, the planar lightwave circuit module is formed in which optical fiber arrays 1 (1b and 1a) are connected to the input side and the output side of a planar lightwave circuit component 30.

The planar lightwave circuit component 30 is configured in which a waveguide forming area having a planar lightwave circuit 10 is formed on a substrate 11. The waveguide forming area has a cladding made of a silica-based material and a core made of a silica-based material having a refractive index greater than that of the cladding. The core forms the planar lightwave circuit 10. The planar lightwave circuit 10 shown in FIG. 27 has one input optical waveguide 2. The input optical waveguide 2 is branched through branch parts 17, and eight of output optical waveguides 6 are formed.

This planar lightwave circuit 10 is a splitter planar lightwave circuit that divides light inputted from one optical input part 41 and outputs it from eight optical output parts. The splitter planar lightwave circuit is a 1×8 splitter. The optical input part 41 of the planar lightwave circuit 10 shown in FIG. 27 is the input side of the input optical waveguide 2, and the optical output part is the output side of the output optical waveguides 6.

In addition, in FIG. 27, upper plates 43 and 44 made of glass are disposed on the connection end faces 26b and 26a sides of the planar lightwave circuit component 30.

Optical fiber arrays 1 (1a and 1b) have guide substrates 23 (23a and 23b) and retainer plates 24 (24a and 24b) Furthermore, the thickness of the guide substrates 23 (23a and 23b) and the retainer plates 24 (24a and 24b) is set to 1.0 mm in general.

Moreover, not shown in FIG. 27, however, at least one optical fiber guide groove is formed in each of the guide substrates 23 (23a and 23b), and optical fibers 7 are inserted and fixed to the optical fiber guide grooves. The optical fiber guide grooves are formed into a V-groove (V-shaped groove). The optical fibers 7 are fixed by the guide substrates 23 (23a and 23b) and the retainer plates 24 (24a and 24b) with an adhesive (not shown in FIG. 27).

In the planar lightwave circuit module shown in FIG. 27, one optical fiber 7 is fixed to the optical fiber array 1 (1b) disposed on the input side, and the optical fiber 7 is connected to the input optical waveguide 2 of the planar lightwave circuit component 30. The optical fiber 7 is drawn from a coated optical fiber 22 and it is inserted into the optical fiber guide groove with the sheath on the connection end face side removed. The optical fiber 7 inserted into the optical fiber guide groove is held by the retainer plate 24 (24b).

In the meantime, eight optical fibers 7 are fixed to the optical fiber array 1 (1a) disposed on the output side at equal pitches. The optical fibers 7 on the output side are drawn from a optical fiber ribbon 21. The optical fibers 7 are inserted into the optical fiber guide grooves with the sheaths of the connection end faces removed, and they are held by the retainer plate 24 (24a).

The optical fibers 7 on the output side are connected to the corresponding output optical waveguides 6 of the planar lightwave circuit component 30. The optical fiber ribbon 21 is formed in which the optical fibers 7 are arranged in parallel in a row at a pitch of 250 μm, about two times the diameter of the optical fibers 7.

The optical fiber guide grooves are formed on the guide substrates 23 of the optical fiber arrays 1 as described above. The pitch of the optical fiber guide grooves is formed to be 250 μm in general. The pitch (250 μm) is equal to the pitch of the optical fibers 7 of the optical fiber ribbon 21.

In addition, such the guide substrate 23 is used as well that the pitch of the optical fiber guide grooves is 127 μm. The pitch (127 μm) is almost equal to the diameter of the optical fibers 7. In this manner, the optical fibers 7 can be arranged with nearly no clearance in the guide substrate having the pitch of the optical fiber guide grooves nearly equal to the diameter of the optical fibers 7.

In such the planar lightwave circuit module as shown in FIG. 27, connection end faces 16a and 16b of the optical fiber arrays 1 (1a and 1b) and the connection end faces 26a and 26b of the planar lightwave circuit component 30 are polished, and then they are assembled. The optical fiber array 1 (1b) is faced to the input side end face of the planar lightwave circuit component 30, and the optical fiber array 1 (1a) is faced to the output side end face of the planar lightwave circuit component 30.

Then, the optical fibers 7 arranged in the optical fiber arrays 1 (1a and 1b) are faced to the connection end faces of the optical waveguides arranged in the planar lightwave circuit components 30 (in this case shown in FIG. 27, the input optical waveguide 2 and the output optical waveguides 6).

The optical fiber arrays 1 (1a and 1b) are arranged such that the connection end faces of the corresponding optical fibers 7 are placed at the positions (alignment positions) to have the minimum offset (displacement) with the connection end faces 16a and 16b of the optical waveguides. At these alignment positions, the connection end faces of the optical fiber arrays 1 (1a and 1b) are bonded and fixed to the connection end faces 26a and 26b of the planar lightwave circuit component 30 with a UV curable adhesive.

In addition, in FIG. 27, the connection end faces 16a and 16b of the optical fiber arrays 1 (1a and 1b) and the connection end faces 26a and 26b of the planar lightwave circuit component 30 are illustrated in the faces orthogonal to the optical axis of the optical fibers 7 and the optical waveguides. However, the connection end faces 16a, 16b, 26a and 26b are generally formed into slopes. In this manner, when the connection end faces 16a, 16b, 26a and 26b are formed into slopes, the adverse effect due to the reflected light that reflects in the connection end faces 16a, 16b, 26a and 26b can be prevented.

Furthermore, the connection end faces 16a and 16b of the optical fiber arrays 1 (1a and 1b) and the connection end faces 26a and 26b of the planar lightwave circuit component 30 are positioned such that the thickness of an adhesive layer has a constant value, such as about five micrometers. The thickness adjustment of the adhesive layer is performed to stabilize the strength of bonding.

Various exemplary configurations of the planar lightwave circuit component 30 are known. For example, other than the splitter, an arrayed waveguide grating (AWG) as shown in FIG. 28 is widely known.

The arrayed waveguide grating serves as a wavelength multiplexer and demultiplexer in wavelength multiplexing transmission. The wavelength multiplexing transmission is that a plurality of lights having a different wavelength each other is multiplexed and transmitted through a single optical fiber, which is a transmission method to dramatically enhance the transmission capacity.

A planar lightwave circuit 10 of the arrayed waveguide grating has at least one input optical waveguide 2, a first slab waveguide 3 connected to the output side of the input optical waveguide 2, an arrayed waveguide 4 connected to the output side of the first slab waveguide 3, a second slab waveguide 5 connected to the output side of the arrayed waveguide 4, and output optical waveguides 6 connected to the output side of the second slab waveguide 5. The arrayed waveguide 4 is formed of a plurality of channel waveguides 4a arranged side by side, and a plurality of the output optical waveguides 6 are arranged side by side.

The arrayed waveguide 4 is for transmitting the light led out from the first slab waveguide 3, in which the channel waveguides 4a are formed to have a length different from each other and the length of each adjacent channel waveguide 4a is varied from each other at ΔL.

In addition to this, the channel waveguides 4a are generally disposed in large numbers such as a hundred waveguides. Furthermore, the output optical waveguides 6 are disposed corresponding to the number of signal lights having a different wavelength each other, the lights are multiplexed or the multiplexed light is demultiplexed by the arrayed waveguide grating, for example. However, in FIG. 28, the numbers of the output optical waveguides 6, the channel waveguides 4a and the input optical waveguide 2 are illustrated simply for simplifying the drawing.

An optical fiber on the transmission side (not shown in FIG. 28) is connected to the input optical waveguide 2, and a wavelength-multiplexed light is led into the input optical waveguide 2. The wavelength-multiplexed light that was passed through the input optical waveguide 2 and led to the first slab waveguide 3 spreads by the diffraction effect, enters the arrayed waveguide 4 and transmits through the arrayed waveguide 4.

The multiplexed light transmitted through the arrayed waveguide 4 reaches the second slab waveguide 5 and each demultiplexed light focuses on the output optical waveguides 6 for output. Here, the length of each adjacent channel waveguide 4a of the arrayed waveguide 4 is varied from each other at a set amount. Therefore, the phase of the light is shifted after transmitting through the arrayed waveguide 4, the phasefront of each focusing devided (demultiplexed) light is tilted according to the shift amount, and the tilted angle determines the position to focus.

On this account, the focusing positions of the demultiplexed lights having a different wavelength each other are varied from each other. The output optical waveguides 6 is formed at the positions, and thus the lights having a different wavelength each other (demultiplexed lights) can be outputted from the separate output optical waveguides 6 at every wavelength.

More specifically, the arrayed waveguide grating has the function of demultiplexing in which it demultiplexes multiplexed light having a plurality of wavelengths different from each other inputted from the input optical waveguide 2 and it outputs demultiplexed lights from the separate output optical waveguides 6. The center wavelength of the lights to be demultiplexed by the arrayed waveguide grating is proportional to the length difference (ΔL) of the adjacent channel waveguides 4a of the arrayed waveguide 4 and the effective refractive index (equivalent refractive index) n_{c} of the arrayed waveguide 4.

In addition, FIG. 29 shows the exemplary configuration of another planar lightwave circuit component 30. A planar lightwave circuit 10 of the planar lightwave circuit component 30 is the optical wavelength multiplexing and demultiplexing circuit for use in multiplexing the pumping light of an optical amplifier, for example. The planar lightwave circuit 10 is formed to connect a plurality of Mach-Zehnder interferometer circuits 15 in multiple stages.

The separate Mach-Zehnder interferometer circuits 15 have first optical waveguides 18 and second optical waveguides 12 arranged side by side as spacing them each other. Directional coupling parts 13 formed to have the first optical waveguides 18 and the second optical waveguides 12 arranged adjacently are disposed with space in the longitudinal direction of the optical waveguides.

As shown in FIG. 29, the circuit of the Mach-Zehnder interferometer circuits 15 connected in multiple stages can multiplex the lights with four different wavelengths λ1, λ2, λ3 and λ4, which have been inputted from the separate input optical waveguides 2. In this case, the multiplexed light is outputted from the output optical waveguide 6. In the mean time, the circuit shown in FIG. 29 can demultiplex the wavelength-multiplexed light with four wavelengths λ1, λ2, λ3 and λ4 into the lights with the separate wavelengths inversely to the above.

Furthermore, in this type of the circuit which the Mach-Zehnder interferometer circuits 15 are connected in multiple stages, the number of the Mach-Zehnder interferometer circuits 15 connected is increased by one more stage than that of the circuit shown in FIG. 29, whereby allowing the lights or light with eight wavelengths to be multiplexed or demultiplexed. Moreover, the number of the Mach-Zehnder interferometer circuits 15 connected is increased furthermore by two stages, whereby allowing the lights or light with 16 wavelengths to be multiplexed or demultiplexed.

The circuit formed of the Mach-Zehnder interferometer circuits 15 connected in multiple stages is used as a wavelength multiplexer for multiplexing the pumping light of an optical amplifier, for example.

At present, in the field of optical communications, an erbium-doped fiber amplifier (EDFA) is widely used in which erbium is added to an optical fiber. To allow the EDFA in the pumped state, the light of a wavelength of near 1480 nm or 980 nm needs to be injected.

Then, the stronger the intensity of the light is, the greater the gain of the optical fiber becomes. To this end, in order to grow the gain of the optical amplifier, the intensity of the pumping light needs to be strong. However, the intensity of the light emitted from a semiconductor laser diode (LD) that is used for the light source for pumping has limitation. Therefore, a method is adapted in which a plurality of semiconductor laser diodes is used to grow the power of the light to be inputted to the EDFA.

At this time, adopted is a method of efficiently combining the lights emitted from the plurality of the semiconductor laser diodes by combining (multiplexing) the lights in different polarization states (polarization combination), or by combining (multiplexing) the lights with slightly different wavelengths (wavelength combination).

The circuit of the Mach-Zehnder interferometer circuits 15 connected in multiple stages shown in FIG. 29 is used for such wavelength combination (wavelength multiplexing) of the pumping light.

The optical components used for such the purposes are required for durability against light, in addition to durability against environments such as temperature and humidity. More specifically, in the wavelength multiplexer for multiplexing and outputting the emitted lights from the plurality of laser diodes, the optical power passing through the output optical waveguides 6 of the planar lightwave circuit component 30 reaches as much as a few hundreds milliwatts. Thus, an optical fiber module having the connection configuration as durable to such high intensity light is required.

Moreover, in order to improve the characteristics of the optical fiber module, it is also important to optimize the configuration of the optical fiber array to be connected to the planar lightwave circuit component 30. Then, for example, a traditional optical fiber array applied to the formation of the optical fiber module will be described.

FIG. 35 illustrates one example of an optical fiber array 1. The optical fiber array 1 has 32 of optical fibers 7 arranged at the pitch nearly equal to the diameter of the optical fiber 7. In a guide substrate 23, optical fiber guide grooves 9 are formed at the pitch P₁ of 127 μm nearly equal to the diameter of the optical fiber 7. The optical fibers 7 are inserted and fixed to the separate optical fiber guide grooves 9.

In this case, as shown in FIG. 35, the optical fiber array 1 is overlaid with optical fiber ribbons 21 (21a and 21b) in two stages. Then, for example, as shown in the schematic diagrams in FIGS. 36A and 36B, the optical fibers 7 (7a) arrayed in the optical fiber ribbon 21a and the optical fibers 7 (7b) arrayed in the optical fiber ribbon 21b are arranged.

More specifically, the optical fibers 7 (7a) are disposed over the optical fibers 7 (7b) as shown in FIG. 36A, the optical fibers 7 (7b) are arranged between the spaces of the optical fibers 7 (7a) on the tip end side as shown in FIG. 36B, and the optical fibers 7 (7a) and optical fibers 7 (7b) are arranged alternately. Then, as shown in FIG. 35, the optical fibers 7 (7a and 7b) are inserted into the optical fiber guide grooves 9 in the guide substrate 23 (23a) to from the optical fiber array 1.

Alternatively, in the type of the optical fiber array where a plurality of the optical fiber ribbons 21 is arranged side by side as shown in FIG. 35, there is an example of adapting the configuration below. More specifically, there is also the configuration in which the pitch P₂ between the optical fibers 7 of the adjacent optical fiber ribbons 21 is formed to be slightly wider than the pitch P₁ of the optical fibers 7 in optical fiber ribbon 21. The configuration can avoid the interference of the optical fiber ribbons 21 such that the sheaths of the adjacent optical fiber ribbons 21 are interfered each other.

In this configuration, when the pitch P₁ of the optical fiber guide grooves is 127 μm, for example, the pitch P₂ between the optical fibers 7 of the adjacent ribbons is set from 254 to 500 μm, for example. In the meantime, when the pitch P₁ of the optical fiber guide grooves is 250 μm, the pitch P₂ between the optical fibers 7 of the adjacent ribbons is set from 360 to 500 μm, for example.

Furthermore, the optical fiber array 1 is generally formed to arrange the optical fibers 7 drawn from the optical fiber ribbons 21. Typically, four or eight of the optical fibers 7 are arrayed in a optical fiber ribbon 21. Therefore, the number of the optical fibers 7 to be arrayed in the optical fiber array is generally set to 4, 8, 12, 16, 20, 24, 32 and so on.

In the meantime, the traditional optical fiber module having the circuit configuration shown in FIG. 29 and having the planar lightwave circuit component 30 connected to the optical fiber arrays 1 (1a and 1b) with an adhesive has had a problem that the durability against light is not excellent. In addition, the optical fiber module is formed in which the corresponding optical fiber arrays 1 (1a and 1b) are disposed at both end sides of the planar lightwave circuit component 30 and they are connected with the adhesive.

That is, since the intensity of the output light (multiplexed light) is great in the circuit configuration shown in FIG. 29, the adhesive is deteriorated when the adhesive exists at the connecting part of the output side of the planar lightwave circuit component 30 to the optical fiber array 1. The adhesive deterioration has the deterioration due to the light that the adhesive absorbs high intensity light, and the deterioration due to temperature rise that is caused by the adhesive having absorbed the light.

For example, the inventor passed the light of 500 mW through the optical fiber module that the planar lightwave circuit component 30 having the circuit configuration shown in FIG. 29 was connected to the optical fiber arrays 1 (1a and 1b) with an adhesive. Consequently, the insertion loss of the optical fiber module increased as large as about one decibel due to the light transmission for 1000 hours.

Then, in the optical fiber module allowed such high intensity light to be passed, a technique has been adapted in which the output side of the planar lightwave circuit component 30 is connected to the optical fiber array 1 with no adhesive.

For example, as shown in FIG. 30, the optical fiber module is formed in which an MT connector-like optical connector 32 is fit to the output end side of the planar lightwave circuit component 30. Furthermore, in the optical fiber module, the optical fiber array, which is connected to the output end side of the planar lightwave circuit component 30, is formed into the MT connector-like optical connector 33. Moreover, the optical fiber module has the configuration in which the optical connectors 32 and 33 are connected through guide pins 34 and a cramp spring 35.

Besides, in the optical fiber module shown in FIG. 30, the connection end faces of the optical fibers 7 are formed to project more slightly than the connection end face of the optical connector 33. According to the configuration, the optical fiber module allows the optical fibers 7 to be contacted and connected to the optical waveguides of the planar lightwave circuit component 30.

FIG. 31 shows the exemplary configuration of multiplexing lights using the optical fiber module shown in FIG. 30. The example is that the lights of wavelengths λ1, λ2 . . . λn emitted from semiconductor laser diodes 37 are inputted to the input side of the optical fiber module shown in FIG. 30 and the lights with wavelengths different from each other are multiplexed. In FIG. 31, the light of the wavelength λ1 is combined with two lights in different polarization states (the light in the TE mode and the light in the TM mode) with a polarized beam combining module 36 before wavelength combination.

In this manner, when the polarization combination using the polarized beam combining module 36 is adapted, the lights from a larger number of laser diode light sources can be combined. Moreover, the optical fiber module shown in FIG. 31, the output end side of the planar lightwave circuit component 30 is connected to the optical fibers 7 disposed on the output end side of the planar lightwave circuit component 30 with no adhesive. On this account, the optical fiber module can suppress the deterioration of the characteristics due to the adhesive deterioration even after high intensity light has passed for long hours.

However, the optical fiber module having the connection configuration as shown in FIGS. 30 and 31 has had problems that it has a complex configuration more than that of the optical fiber module having the planar lightwave circuit component 30 connected to the optical fiber array with the adhesive and the price is high.

In addition, with the development of optical communications, transmission distances are elongated, and to increase the gain of an optical amplifier adapted to optical communications is being considered. Then, the power of the pumping light to be injected to the optical amplifier is also desired to be great. For example, a pumping laser diode capable of emitting high intensity light as large as 300 to 500 mW by a single laser diode has been developed for practical use.

To this end, in the optical fiber module, the necessity occurs to adapt the connection configuration with no adhesive only to the optical output end side of the planar lightwave circuit component 30 but also to the optical input end side.

However, when a plurality of the optical waveguides of the planar lightwave circuit component 30 is connected to a large number of the optical fibers 7 with the MT connector-like optical connectors 32 and 33 as shown in FIGS. 30 and 31, significantly highly accurate techniques are required. If so, the optical fiber module becomes expensive more and more, and the yield becomes low.

Furthermore, the performance of enduring the passing high intensity light is required not only for wavelength multiplexer and demultiplexers used in the optical amplifier but also for various wavelength multiplexer and demultiplexers. Thus, the optical fiber module endurable against high intensity light is demanded.

For example, due to the development and advance of wavelength division multiplexing communications, the number of wavelengths to be multiplexed is greater. In recent years, the development and practical use of wavelength division multiplexing communications has been conducted in which 64 to 128 wavelengths are multiplexed for communication. Furthermore, it is advanced that a laser diode used as the signal light (light for communication) is formed to have high intensity (high output power). Those having the output power exceeding 10 mW per laser diode are in practical use. Moreover, the development of the laser diode for emitting signal light over 40 mW has been conducted as well.

In the case of using such the laser diodes for a signal light source, the light intensity after multiplexed is not so greater when the number of multiplexed wavelengths is a few. Thus, problems have not arisen even in the traditional connection with the adhesive. However, when the number of multiplexed wavelengths is greater, the light intensity after multiplexed is greater and the adhesive deterioration due to light becomes a problem.

For example, in the case that the number of multiplexed wavelengths is 64 waves, when 64 of laser diode lights emitted from laser diodes having a light intensity of 10 mW, the light intensity exceeds 300 mW even though the insertion loss of the wavelength multiplexer such as the arrayed waveguide grating is extracted, for example.

If so, it is also necessary to configure the optical fiber module as durable against high intensity light, which is formed to have the planar lightwave circuit component 30 with the arrayed waveguide grating circuit connected to the optical fibers 7.

However, when the planar lightwave circuit component 30 with the arrayed waveguide grating circuit is connected to the optical fiber array 1 disposed with the optical fibers 7 with the adhesive in the traditional manner, the adhesive is deteriorated. In addition, since the arrayed waveguide grating circuit is large, it is significantly difficult to adapt the connection configuration shown in FIG. 30 to connecting the planar lightwave circuit component 30 with the arrayed waveguide grating circuit to the optical fiber array 1.

In future, separate signal lights tend to be high intensity light, and the number of wavelengths to be multiplexed tends to be greater as well. Thus, the light intensity after multiplexed is expected to be higher intensity light. Accordingly, optical fiber modules having the configuration of the connecting part durable against high intensity light is needed more and more.

Furthermore, the performance of enduring high intensity light of optical components is demanded not only for the planar lightwave circuit module but also for any types of optical fiber modules formed to have optical components connected to each other. However, in various optical fiber modules as shown in FIGS. 32, 33, 34A and 34B, the adhesive is used for connecting the optical components, and each of them has had the same problems. Therefore, an optical fiber module easily fabricated and excellent in the characteristics of enduring high intensity light has been demanded.

In addition to this, the optical fiber modules shown in FIGS. 32 and 33 are the filter type optical fiber modules using a dielectric multi-film filter. These optical fiber modules use an adhesive 50 to connect a sleeve (ferrule) 38 for holding optical fibers (not shown) to a lens (GRIN lens) 39 and a dielectric multi-film filter 40. The dielectric multi-film filter 40 is formed to have a dielectric multilayer 42 on a substrate 51.

These optical fiber modules are disclosed in Japanese patent Applications (JP-A-2001-91789 and JP-A-11-337765) and U.S. Pat. No. 6,084,994, omitting the detailed description of the principles and functions thereof.

Furthermore, FIGS. 34A and 34B illustrate examples of optical fiber modules for polarization combination. These optical fiber modules have two prisms 45a and 45b bonded with an adhesive 50. An optical film 48 is formed on the connection end face of the prism 45a, and the optical film 48 forms the reflecting surface of light. The polarized beam combining module is disclosed in U.S. Pat. No. 5,740,288 in detail, omitting the detailed description.

Moreover, as shown in FIG. 34B, the connection of the prisms 45a and 45b to optical fibers 7 is done through ferrules 46 and collimators (lenses) 47. The adhesives 50 are applied in each of the connection end faces of the prisms 45a and 45b, the ferrules 46 and the collimators (lenses) 47.

In FIGS. 32, 33, 34A and 34B, the thickness of the adhesive 50 is illustrated thick for easily understanding the description, but the thickness of the adhesive 50 is actually in order of a few to ten and a few micrometers. In addition, the examples of the same optical fiber modules as above are also shown in U.S. Pat. No. 6,169,626 B1 and U.S. Pat. No. 6,023,542.

Besides, as described above, the optical fiber module is formed to connect the planar lightwave circuit component 30 to the optical fiber array 1. On this account, it has a problem of increasing the connection loss due to fabrication variations in the optical fiber array 1, thus having sought an optical fiber array with small fabrication variations.

For example, the optical fiber guide grooves in the guide substrate 23 used for the optical fiber array 1 are formed by cutting, etching or molding, but the groove pitch has errors due to fabrication variations. In addition, as generally known, the optical fiber 7 is formed to dispose a cladding layer around the core where light passes through, having the configuration in which the cross section is circular and the core is placed at the center. However, fabrication variations exist even in the core position.

Because of the fabrication variations, the optical fiber array 1 has the shift of the pitch. The shift of the pitch is the displacement in the arranging direction of the optical fibers 7 and in the depth direction orthogonal to the arranging direction.

In this manner, when the shift of the pitch exists in the optical fiber array 1, the offset (displacement) between the connection end faces of the optical fibers 7 and the optical waveguides (input optical waveguide 2 and output optical waveguides 6) becomes great in connecting the optical fiber array 1 to the planar lightwave circuit component 30, thus causing a problem of increasing the connection loss.

This connection loss is proportional to the offset to the second power, generating the excessive connection loss about 0.2 to 0.4 dB at an offset of one micrometer. In addition, the connection loss value is varied according to the types of the optical fibers 7 and the characteristics of the optical waveguides. Therefore, the shift of the pitch in the optical fiber array 1 is desirably as small as possible. However, an offset of about one micrometer is actually regarded as an acceptable value. For example, there is sometimes an offset of about 0.75 μm at the maximum in reality.

Furthermore, in fabricating the optical fiber array 1, it is general to use the adhesive for fixing the optical fibers 7 as described above. The adhesive generally has the characteristic of shrinkage in curing. Thus, a stress is applied to the optical fiber arrays 1 (1a and 1b) by the shrinkage in curing, consequently generating a warp.

Then, when a warp is generated in the optical fiber arrays 1, the offset amount between the optical fibers 7 and the optical waveguides will become greater in connecting the optical fiber arrays 1 to the planar lightwave circuit component 30. In addition, when the optical fiber arrays 1 with a warp undergoes temperature changes or is exposed to high temperature, high humidity environments and then the elastic modulus of the adhesive is varied or the adhesive is expanded, the warp amount might be changed.

In this manner, when the warp amount of the optical fiber arrays 1 is changed, a problem arises that the connection loss of the optical fibers 7 to the optical waveguides is varied and the total insertion loss of the optical fiber module is varied as well. Furthermore, when the warp amount of the optical fiber arrays 1 is changed, a stress is applied to the connecting parts of the optical fiber arrays 1 to the planar lightwave circuit component 30, thus causing a problem that the connecting parts are removed and damaged.

For example, when the warp of the optical fiber arrays 1 is below 0.5 μm, the influence upon the offset between the optical fibers 7 and the optical waveguides exerted by the warp is below 0.25 μm, which is a half of the warp amount. Thus, it does not cause a big problem so much. However, when the warp amount is 0.5 μm or greater, the total offset amount sometimes becomes one micrometer or greater, combining with the offset amount caused by the fabrication error of the optical fiber arrays 1. Therefore, it might cause a problem.

Moreover, when the warp of the optical fiber arrays 1 is below 0.5 μm, the offset is changed in the slight amount and the connection loss of the optical fibers 7 to the optical waveguides is changed slightly as well, even though the warp is varied by temperature changes to release it, for example. Besides, the stress applied to the connecting parts of the optical fiber arrays 1 to the planar lightwave circuit component 30 is a slight amount as well, not causing a big problem.

However, when the warp amount becomes 0.5 μm or greater, the connection loss is changed greatly when the warp is released. In addition, in this case, it is highly likely to generate problems such as the removal of the connecting parts due to the stress applied to the connecting parts of the optical fiber arrays 1 (1a and 1b) to the planar lightwave circuit component 30. Because of these reasons, the warp amount of the optical fiber arrays 1 is desirably below 0.5 μm.

Traditionally, the mainstream of the planar lightwave circuit component 30 adapted to the optical fiber modules such as the planar lightwave circuit module has been a 1×9 splitter or 1×16 splitter, or an arrayed waveguide grating for multiplexing and demultiplexing 8 to 16 of wavelengths. Therefore, the number of the optical fibers 7 to be arranged in the optical fiber arrays 1 adapted to the planar lightwave circuit module has been eight or 16 fibers, and the warp amount of the optical fiber arrays 1 has been small.

However, as described above, nowadays it has been proceeding to form the planar lightwave circuit component 30 into a multifunction product. According with this, for example, the development and practical use of such a splitter planar lightwave circuit component 30 has been conducted that light inputted from a single optical input part is divided and outputted from 32 of the optical output parts or 64 of the optical output parts. In addition, also in the arrayed waveguide grating, those having the number of multiplexing lights and demultiplexing light being 40 or greater have been in practical use. Those having the number of multiplexing lights and demultiplexing light being 60 or greater have been developed as well.

Consequently, the planar lightwave circuit module formed by adapting such the planar lightwave circuit components 30 needs to have the number of the optical fibers 7 arranged in the optical fiber arrays 1 set from 32 to 60 or greater corresponding to the planar lightwave circuit components 30. However, when 32 to 60 or greater of the optical fiber guide grooves are formed in the traditional guide substrate 23 of a thickness of 1.0 mm to form the optical fiber arrays 1, a problem has arisen that the warp amount of the optical fiber arrays 1 becomes greater.

For example, FIG. 37A illustrates an example of an optical fiber array 1 having a guide substrate 23 made of Pyrex Glass of a thickness of 1.0 mm. In the optical fiber array 1, 32 of optical fiber guide grooves 9 are formed in the guide substrate 23 at a pitch of 250 μm, and optical fibers 7 are disposed in the separate optical fiber guide grooves 9. A retainer plate 24 made of Pyrex Glass of a thickness of 1.0 mm is disposed over the guide substrate 23. Pyrex is a registered trademark.

In addition, as shown in FIG. 37B, the optical fiber 7 is fixed to the optical fiber guide groove 9 with an adhesive 50.

As shown in FIG. 37C, the optical fiber array 1 is warped as much as about 2.8 μm by curing the adhesive 50, and the offset amount between the optical fibers 7 and the optical waveguides due to the warp becomes about 1.4 μm at the maximum. Accordingly, an offset of about 2.15 μm at the maximum was generated, combining with the offset amount caused by the other factors such as the fabrication error of the optical fiber guide grooves 9.

On this account, a problem has arisen that the connection loss of the optical fiber arrays 1 to the planar lightwave circuit component 30 becomes about 1.8 dB at the maximum when the optical fiber array 1 shown in FIGS. 37A, 37B and 37C is adapted to form the planar lightwave circuit module.

Furthermore, as described above, the warp amount of the optical fiber array 1 is changed due to the deterioration of the adhesive strength of the adhesive 50 and due to swelling caused by the moisture absorption of the adhesive 50. According with this, the optical fiber module formed by adapting the optical fiber arrays 1 has had a problem that the insertion loss is changed about one decibel over time.

In the meantime, the inventor formed an optical fiber array 1 as another example of the optical fiber array 1 in which 48 of optical fiber guide grooves 9 are formed in a guide substrate 23 made of Pyrex Glass of a thickness of 1.0 mm at a pitch of 127 μm. Then, when the warp due to curing of the adhesive 50 was determined in the optical fiber array 1, the value was 2.0 μm. Besides, also in the optical fiber array 1, optical fibers 7 were disposed in the separate optical fiber guide grooves 9 and a retainer plate 24 made of Pyrex Glass of a thickness of 1.0 mm was disposed over the guide substrate 23.

The offset amount between the optical fibers 7 and the optical waveguides of the planar lightwave circuit component 30 generated by the warp of the optical fiber array 1 is about 1.0 μm at the maximum. The offset amount becomes about 1.75 μm at the maximum, combining with the offset amount generated by the other factors. Then, in the planar lightwave circuit module, the connection loss of the optical fiber arrays 1 to the planar lightwave circuit component 30 was about 1.2 dB at the maximum, and the insertion loss change was about one decibel accompanying with the changed warp amount due to the deterioration of the adhesive strength of the adhesive 50.

Furthermore, according with the changed warp amount, a stress was applied to the connecting parts of the planar lightwave circuit component 30 to the optical fiber arrays 1, and the removal of the connecting parts were sometimes observed in the planar lightwave circuit module.

### SUMMARY OF THE INVENTION

The invention is to provide a following optical fiber module in one aspect. More specifically, the optical fiber module of the invention comprises:

at least one bonding part connecting optical components with an adhesive, the optical components having connection end faces faced to each other,

wherein at least one of the bonding parts has a no adhesive filled part where the adhesive is not applied in a light transmitting area.

### BRIEF DESCRIPTION OF THE DRAWINGS

A more complete appreciation of the invention and many of the attendant advantages there of will become readily apparent with reference to the following detailed description, particularly when considered with reference to the accompanying drawings, in which:

FIG. 1A is a plan view illustrating the configuration of the essential part of a first embodiment of an optical fiber module in the invention;

FIG. 1B is a side view of FIG. 1A;

FIG. 2 is an explanatory view illustrating the configuration of the essential part of the optical fiber module of the first embodiment in the disassembled state;

FIG. 3A is an explanatory view illustrating an optical fiber array adapted to the optical fiber module of the first embodiment by a perspective view;

FIG. 3B is a plan view illustrating the connection end face side of the optical fiber array shown in FIG. 3A;

FIG. 3C is a front view illustrating the connection end face of the optical fiber array shown in FIG. 3A;

FIG. 4 is a graph illustrating the variation of the insertion loss when high intensity light is passed through the optical fiber module of the first embodiment;

FIG. 5A is a front view illustrating a connection end face of another example of the optical fiber array adapted to the optical fiber module of the invention;

FIG. 5B is a side view illustrating the connection end face side of another example of the optical fiber array adapted to the optical fiber module of the invention;

FIGS. 6A and 6B are explanatory views illustrating the configuration of the connection end face of still another example of the optical fiber array adapted to the optical fiber module of the invention;

FIG. 7 is an explanatory view illustrating the configuration of the essential part of a second embodiment of the optical fiber module in the invention in the disassembled state;

FIG. 8 is a perspective explanatory view illustrating an optical fiber array adapted to the second embodiment;

FIG. 9 is a perspective explanatory view illustrating yet another example of the optical fiber array adapted to the optical fiber module of the invention;

FIG. 10A is a plan view illustrating the connection end face side of the optical fiber array of yet another example of the optical fiber module of the invention;

FIG. 10B is a front view of a connection end face of the optical fiber array shown in FIG. 10A;

FIG. 11A is a front view illustrating a connection end face of still yet another example of the optical fiber array adapted to the optical fiber module of the invention;

FIG. 11B is a side view illustrating the connection end face side of the optical fiber array shown in FIG. 11A;

FIG. 12 is a plan explanatory view illustrating a connecting part of another embodiment of the optical fiber module in the invention;

FIG. 13 is an explanatory view schematically illustrating a connecting part of still another embodiment of the optical fiber module in the invention;

FIG. 14 is an explanatory view illustrating yet another embodiment of the optical fiber module in the invention;

FIG. 15 is a plan explanatory view illustrating still yet another embodiment of the optical fiber module in the invention;

FIG. 16 is a diagram of the configuration of the essential part illustrating a specific example of the first embodiment of the optical fiber array in the invention;

FIGS. 17A and 17B are explanatory views showing the measurement result of the warp in the optical fiber array of sample fabrications of the first embodiment;

FIG. 18 is a graph illustrating the relationship between the total number of optical fiber array guide grooves and the warp amount of the optical fiber array of the first embodiment along with the relationship in comparative examples;

FIG. 19 is a graph illustrating the relationship between the thickness and the warp amount of a guide substrate of the optical fiber array in which the optical fiber array guide grooves are formed at a pitch of 250 μm;

FIG. 20 is an explanatory view illustrating a specific example of the second embodiment of the optical fiber array in the invention by a front view of the connection end face;

FIGS. 21A and 21B are explanatory views illustrating the measurement result of the warp amount of the optical fiber array of sample fabrications of the second embodiment;

FIGS. 22A and 22B are explanatory views illustrating the measurement result of the warp amount of the optical fiber array of other sample fabrications of the second embodiment;

FIG. 23 is a graph illustrating the relationship between the total number of the optical fiber guide grooves and the warp amount of the optical fiber array of the second embodiment along with the relationship of comparative examples;

FIG. 24 is a graph illustrating the relationship between the thickness and the warp amount of a guide substrate of the optical fiber array in which the optical fiber guide grooves are formed at a pitch of 127 μm;

FIG. 25 is a graph illustrating the offset amount between optical fibers and optical waveguides of a planar lightwave circuit component in a planar lightwave circuit module formed by adapting the embodiment of the optical fiber array in the invention;

FIG. 26 is a graph illustrating the relationship between the total number of the optical fiber guide grooves and the warp amount in order to allow the warp amount of the optical fiber array to be about 0.5 μm;

FIG. 27 is an explanatory view illustrating one example of the traditional optical fiber module;

FIG. 28 is an explanatory view illustrating the exemplary configuration of an arrayed waveguide grating;

FIG. 29 is an explanatory view illustrating the exemplary configuration of a planar lightwave circuit component having Mach-Zehnder interferometer circuits in multiple stages;

FIG. 30 is an explanatory view illustrating the connection configuration using a planar lightwave circuit component and an MT connector for an optical fiber array;

FIG. 31 is an explanatory view illustrating an example of adapting the optical fiber module applied to the configuration shown in FIG. 30 to an optical multipexer and demultiplexer;

FIG. 32 is an explanatory view illustrating another example of the traditional optical fiber module;

FIG. 33 is an explanatory view illustrating still another example of the traditional optical fiber module;

FIGS. 34A and 34B are explanatory views illustrating yet another example of the traditional optical fiber module;

FIG. 35 is an explanatory view illustrating the exemplary configuration of the traditional optical fiber array;

FIGS. 36A and 36B are schematic diagrams illustrating the exemplary arrangement form of the optical fibers to be arranged in the optical fiber guide grooves formed at an array pitch nearly equal to the diameter of the optical fibers;

FIG. 37A is an explanatory view illustrating the state before an adhesive is not cured in the optical fiber array by the front view of the connection end face;

FIG. 37B is an enlarged view inside a dashed line A shown in FIG. 37A;

FIG. 37C is an explanatory view illustrating the state after the adhesive is cured in the optical fiber array by the front view of the connection end face;

FIG. 38 is an explanatory view illustrating an example of a method for measuring the warp in the optical fiber array;

FIGS. 39A, 39B, 39C and 39D are explanatory views illustrating examples of the measurement result of the warp in the traditional optical fiber array;

FIGS. 40A, 40B, 40C and 40D are explanatory views illustrating examples of the measurement result of the warp in another traditional optical fiber array; and

FIG. 41 is a graph illustrating the relationship between the total number of the optical fiber guide grooves and the warp amount in the traditional optical fiber array.

### DESCRIPTION OF THE EMBODIMENTS

As one aspect, the invention is to provide an optical fiber module easily fabricated, excellent in the characteristics of enduring high intensity light, and capable of suppressing removal due to temperature changes. Hereafter, the embodiments of the invention will be described with reference to the drawings. In addition, in the description of the following embodiments, the portions having the same designations as the traditional examples are designated the same numerals and signs, omitting or simplifying the overlapping description.

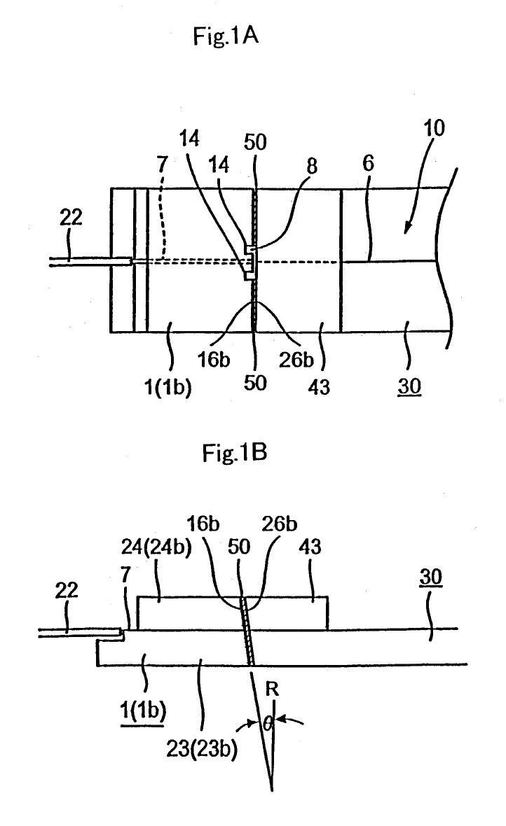

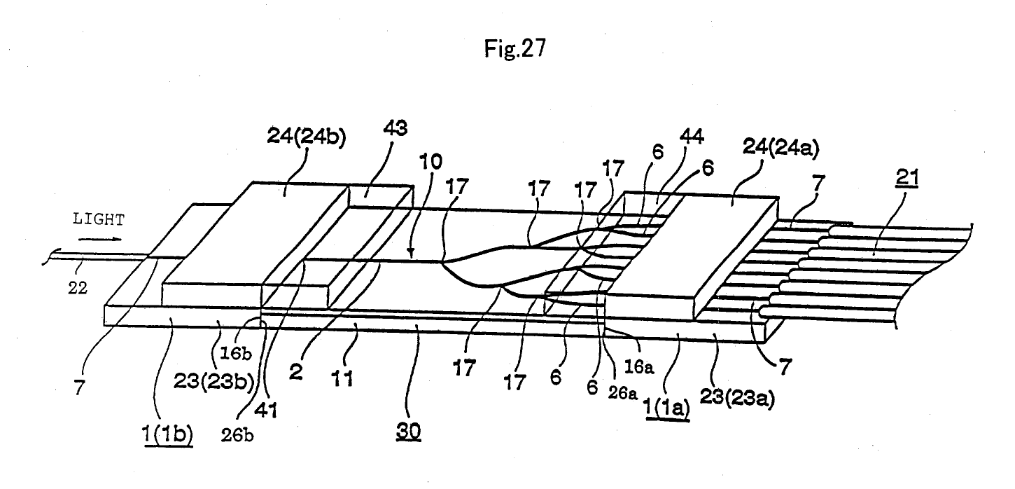

FIGS. 1A and 1B illustrate the configuration of the essential part of a first embodiment of the optical fiber module in the invention, omitting a part of optical components. FIG. 1A is a plan view, and FIG. 1B is a side view. The optical fiber module of the first embodiment is formed to connect a planar lightwave circuit component 30 to optical fiber arrays 1 (1a and 1b) as similar to the optical fiber module shown in FIG. 27. FIGS. 1A and 1B illustrate the connecting part of the optical fiber array 1 (1b) to the planar lightwave circuit component 30, and the peripheral area thereof.

Furthermore, FIGS. 1A and 1B do not show the detailed configuration of a planar lightwave circuit 10 of the planar lightwave circuit component 30. However, in the optical fiber module of the first embodiment, the planar lightwave circuit component 30 has the planar lightwave circuit 10 of a straight waveguide, which is formed straight from the optical input end to the optical output end. The left end sides in FIGS. 1A and 1B are the output side of the optical fiber module. A single output optical waveguide 6 formed in the planar lightwave circuit component 30 is connected to an optical fiber 7 of the optical fiber array 1 (1b).

Moreover, not shown in FIGS. 1A and 1B, the input side of the optical fiber module of the first embodiment has the same configuration of the output side.

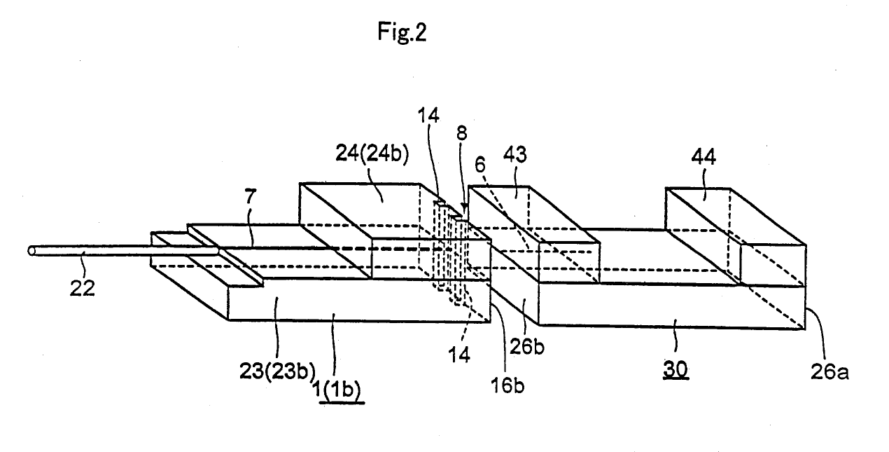

FIG. 2 illustrates the planar lightwave circuit component 30 and the optical fiber array 1 (1b) in the state before connected. Also in FIG. 2, the circuit configuration of the planar lightwave circuit component 30 is omitted.

As shown in FIGS. 1A, 1B and 2, in the optical fiber module of the first embodiment, a connection end face 26b of the planar lightwave circuit component 30 as an optical component is faced to a connection end face 16b of the optical fiber array 1 (1b) as an optical component. The optical fiber module of the first embodiment has a bonding part of connecting the connection end face 26b to the connection end face 16b with an adhesive 50.

As shown in FIG. 1B, the connection end face 26b of the planar lightwave circuit component 30 and the connection end face 16b of the optical fiber array 1 (1b) are formed in slopes that are tilted at the angle θ (θ is an angle of about eight degrees) to the plane R orthogonal to the optical axis of the optical fiber 7. In addition, a connection end face 16a of the optical fiber array 1 (1a) and a connection end face 26a of the planar lightwave circuit component 30 facing to the connection end face are also formed into slopes.

In this manner, the connection end faces 26a, 26b, 16a and 16b are formed into the slopes with the angle, whereby suppressing the influence of the reflected light in the connecting parts as much as possible. Moreover, FIG. 2 and each of the drawings used for the following description of the optical fiber module illustrate the connection end faces 26a, 26b, 16a and 16b as planes orthogonal to the optical axis of the optical fiber 7 not as the slopes. The illustration is for simplifying the drawings.

The feature of the optical fiber module of the first embodiment is in that the module has a no adhesive filled part 8 where the adhesive 50 is not applied in at least one light transmitting area in the bonding part. The no adhesive filled part 8 is formed in the connecting part of the planar lightwave circuit component 30 to the optical fiber array la and in the connecting part of the planar lightwave circuit component 30 to the optical fiber array 1b.

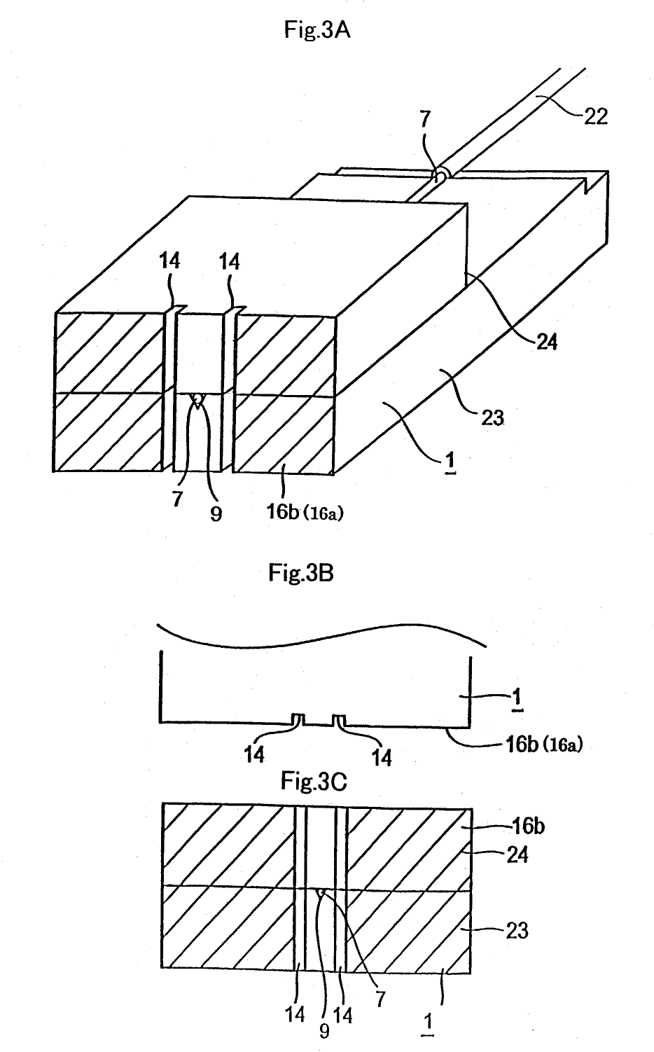

In addition, FIGS. 3A, 3B and 3C illustrate the configuration on the connection end face 16b side or the connection end face 16a side of the optical fiber arrays 1 (1b and 1a). As shown in FIGS. 1A, 1B, 2, 3A, 3B and 3C, in the optical fiber module of the first embodiment, grooves 14 for suppressing the adhesive 50 to be filled into the light transmitting area are formed in the periphery of the no adhesive filled part 8 in at least one of the connection end faces 16a and 16b of the optical components. Furthermore, the grooves 14 are formed in the optical fiber array la and the optical fiber array 1b.

The grooves 14 are formed into a rectangle with a dicing saw, for example. It is fine to form the grooves 14 in a guide substrate 23 and a retainer plate 24 beforehand, or to form them after the optical fiber arrays 1 (1a and 1b) are assembled and the connection end faces 16a and 16b are polished.

FIG. 3A is a perspective view seen from the connection end faces 16a and 16b of the optical fiber arrays 1 (1a and 1b). FIG. 3B is a plan view illustrating the connection end face 16a or 16b of the optical fiber array 1a or 1b. FIG. 3C is the front view. The adhesive 50 is applied in the shaded areas shown in FIGS. 3A and 3C. The adhesive 50 is a UV curable adhesive having a viscosity of 10000 cps or below.

Moreover, the clearance between the connection end face 16b of the optical fiber array 1b and the connection end face 26b of the planar lightwave circuit component 30 is formed to be about five micrometers. The clearance between the connection end face 16b of the optical fiber array la and the connection end face 26a of the planar lightwave circuit component 30 is formed to be about five micrometers as well.

In the optical fiber module of the first embodiment, the optical fiber array 1 (1b) is connected to the planar lightwave circuit component 30 in the following manner, and the no adhesive filled part 8 is formed in the connecting part of the optical fiber array 1 (1b) to the planar lightwave circuit component 30.

More specifically, the connection end face 16b of the optical fiber array 1 (1b) is brought close to the connection end face 26b of the planar lightwave circuit component 30, and light is passed through the optical fiber 7 from the optical waveguides of the planar lightwave circuit component 30. In this state, the optical fiber array 1 (1b) is fixed to the planar lightwave circuit component 30 at the position where the transmitted light is the maximum (at the alignment position).

At this time, the adhesive 50 is poured into the connecting part of the optical fiber array 1 (1b) to the planar lightwave circuit component 30 except the no adhesive filled part 8, in the state that the connection end face 16b of the optical fiber array 1 (1b) is abutted against the connection end face 26b of the planar lightwave circuit component 30 at the alignment position. Then, the adhesive 50 is cured by ultraviolet rays, for example, and the optical fiber array 1 (1b) is fixed to the planar lightwave circuit component 30.

A method for fabricating the optical fiber module is that the connection end faces of optical components to be connected (here, the optical fiber array 1 and the planar lightwave circuit component 30) are abutted against each other, the adhesive is poured into the connecting part of the optical components except the no adhesive filled part in this state, and then the adhesive is cured to fix the optical components. Accordingly, the optical fiber module can be fabricated significantly easily.

In addition, the capillary action is utilized to pour the adhesive 50 into the connecting part of the optical fiber array 1 (1b) to the planar lightwave circuit component 30. The viscosity of the adhesive 50 is 10000 cps or below, whereby the capillary action can be utilized.

Furthermore, the poured adhesive 50 stops at the grooves 14 formed in the connection end face 16b of the optical fiber array 1 (1b), and it does not flow forward from the grooves. On this account, the adhesive 50 does not flow into the light transmitting area between the two grooves 14, and the adhesive 50 can be poured into the connecting part of the optical fiber array 1 (1b) to the planar lightwave circuit component 30 except the no adhesive filled part 8.

In this manner, in the optical fiber module, the configuration, in which the grooves 14 for suppressing the adhesive to be filled into the periphery of the no adhesive filled part are formed in at least one of the connection end faces of the optical components, allows the grooves 14 to suppress the adhesive to be filled into the light transmitting area. Therefore, the configuration can surely form the no adhesive filled part 8, and it can exert the advantages with a simple construction.

In addition, in the optical fiber module of the first embodiment, the optical fiber array 1 (1a) is connected to the optical waveguide component 30 with the similar manner.

When the inventor measured the insertion loss of the optical fiber module thus fabricated, the value was 0.9 dB. It is known that the insertion loss of the optical waveguide component 30 itself is about 0.3 dB. Therefore, the connection loss per optical fiber is about 0.3 dB in the optical fiber module.

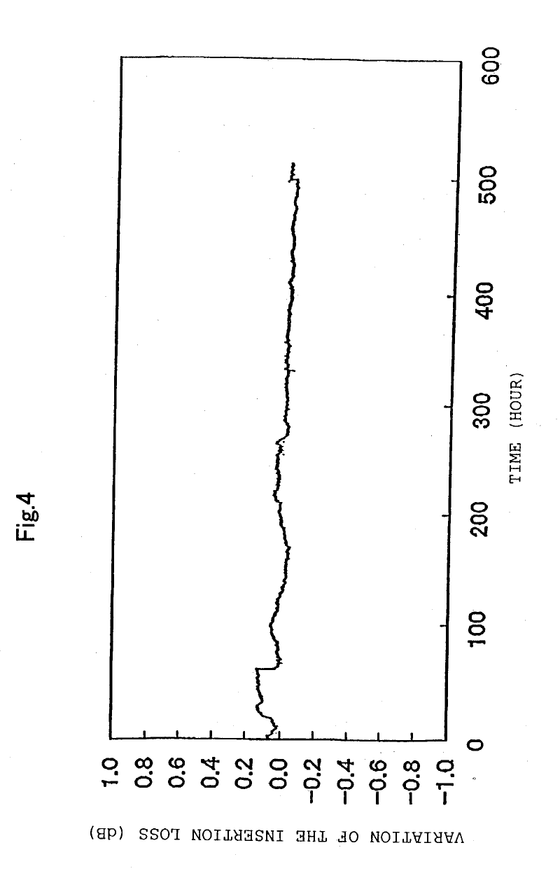

Actually, a high intensity light of one watt was passed through the optical fiber module of the first embodiment. FIG. 4 shows the result of monitoring the variation of the insertion loss at this time. The influence of instability in a measurement system causes minute variations. According to the measurement result, it was confirmed that the optical fiber module of the first embodiment is not deteriorated in the optical characteristics including the insertion loss, and it is significantly stable even after 500 hours or longer.

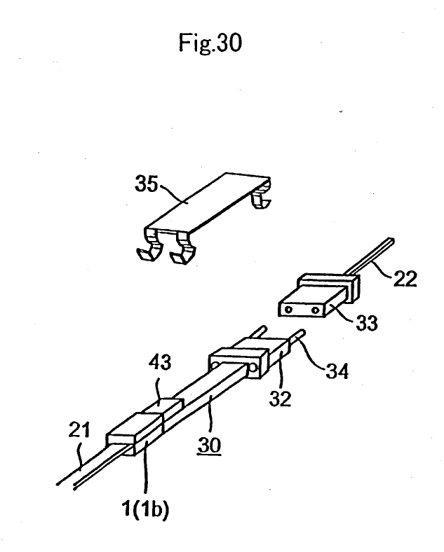

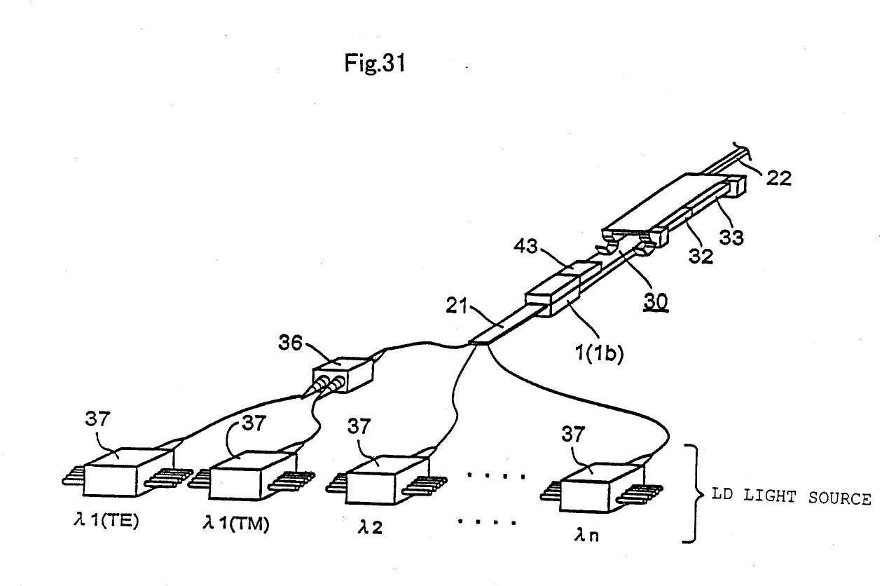

Furthermore, as different from the optical fiber module connected by the connector shown in FIG. 30, the optical fiber module of the first embodiment has the significantly simple configuration with the adhesive 50. Thus, an inexpensive optical fiber module can be realized.

In this manner, according to the optical fiber module of the first embodiment, the optical components to be connected can be assembled easily with the adhesive 50, and the no adhesive filled part 8 is disposed in at least one light transmitting area (for example, a high intensity light passing area) in the bonding part. Consequently, an excellent optical fiber module with the performance of enduring high intensity light can be realized.

Moreover, in the optical fiber module of the first embodiment, at least one of the optical components connected by the connecting parts having the no adhesive filled part is formed to be the planar lightwave circuit component 30, and at least one of them is formed to be the optical fiber array 1.

In this manner, in the optical fiber module having the planar lightwave circuit component 30, the circuit configuration formed in the planar lightwave circuit component 30 is set properly, whereby an optical fiber module having various functions can be realized.

Furthermore, in the optical fiber module of the first embodiment, the grooves 14 for suppressing the adhesive 50 to be filled into the light transmitting area are formed in the connection end faces 16 of the optical fiber arrays 1, and thus work of the grooves 14 can be further facilitated.

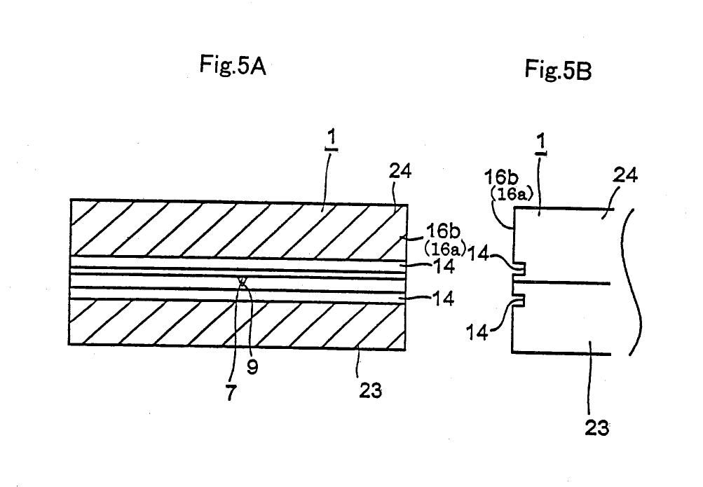

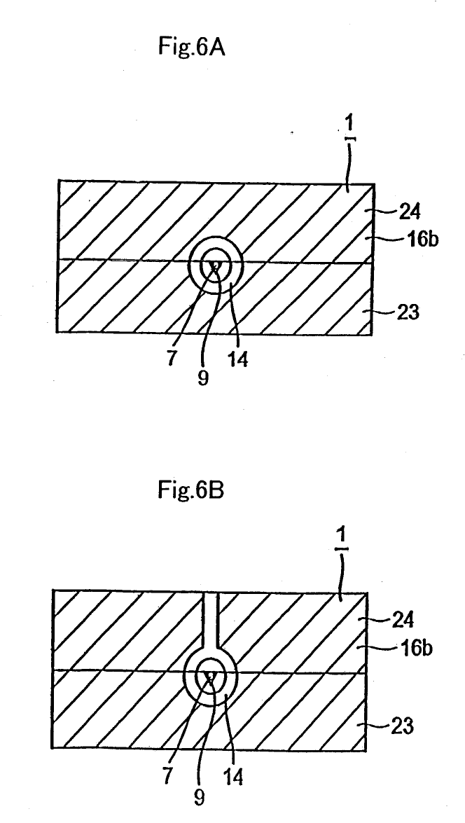

Moreover, FIGS. 5A, 5B, 6A and 6B illustrate other forms of the grooves 14 to be formed in the connection end faces 16a and 16b of the optical fiber arrays 1 (1a and 1b) in the optical fiber module of the first embodiment. The grooves 14 for suppressing the adhesive 50 to be filled into the light transmitting area can be formed in the periphery of the no adhesive filled part 8 in various forms including the forms shown in these drawings. Besides, the adhesive 50 is applied in the shaded areas shown in FIGS. 5A, 6A and 6B.

In addition, it is acceptable that the optical fiber arrays 1 (1a and 1b) and the planar lightwave circuit component 30, which are connected each other, are housed in a package (not shown) in the optical fiber module of the first embodiment. Then, it is fine that a refractive index matching agent is filled in the package and the refractive index matching agent is filled in the no adhesive filled part 8.

The refractive index matching agent is preferably silicon oil having silicon as a main component. An example of the silicon oil is OF-38E made by Shin-Etsu Chemical Co., Ltd. The silicon oil has a viscosity of 1000 cps, and the refractive index is nearly equal to the refractive index of the optical waveguides of the planar lightwave circuit component 30 and the optical fiber 7.

In this manner, the refractive index matching agent is disposed in the no adhesive filled part 8, whereby the refractive index matching agent is interposed in the light transmitting area between the optical waveguides (here, between the input optical waveguide 2 and the output optical waveguide 6) of the planar lightwave circuit component 30 and the optical fiber 7. Then, the connection loss of the optical waveguides of the planar lightwave circuit component 30 to the optical fiber 7 is further reduced.

The silicon oil is easily available and handled, it is easily filled into the package, for example, and it is significantly stable in chemical and heat. Therefore, it is hardly deteriorated even though high intensity light is inputted. In addition, even though the silicon oil is such the silicon oil that will be deteriorated by any possibility, the filled silicon oil is in flux and does not stay at one place, and thus it is hardly deteriorated. Furthermore, new silicon oil is continuously flowed into the no adhesive filled part 8, and thus the temperature rise in the light transmitting area can be avoided.

Accordingly, the connecting parts of the planar lightwave circuit component 30 to the optical fiber arrays 1 (1a and 1b) are free from deterioration due to the high intensity pumping light from the laser diode passed by the circuit of the planar lightwave circuit component 30. Then, the optical fiber module of the first embodiment can realize a highly reliable optical fiber module.

Moreover, as shown in FIGS. 6A and 6B, when the grooves 14 are formed to surround the connection end face of the optical fiber 7, the configuration shown in FIG. 6B is more preferable. More specifically, as shown in FIG. 6B, the configuration in which a part of the groove 14 is communicated with the upper face or bottom face of the optical fiber array 1 (1b) facilitates the refractive index matching agent to be filled into the no adhesive filled part 8, and it is preferable as the embodiment.

Next, a second embodiment of the optical fiber module in the invention will be described. In addition, in the description of the optical fiber module of the second embodiment, the portions having the same designations as the first embodiment are designated the same numerals and signs, omitting or simplifying the overlapping description.

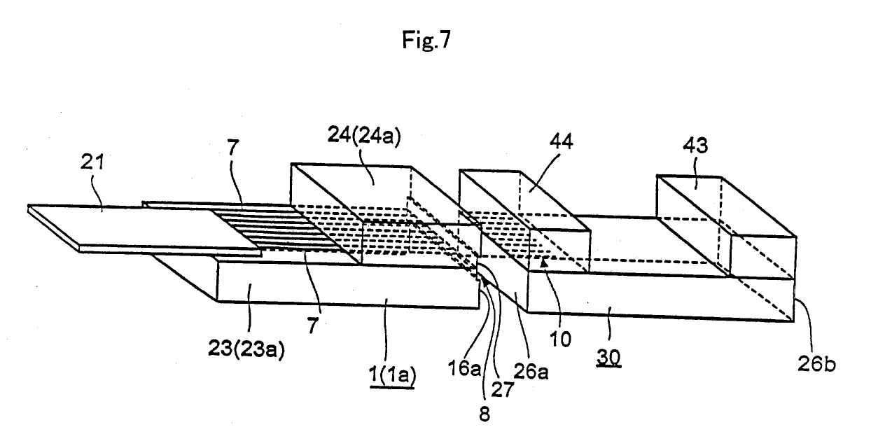

As similar to the first embodiment, the optical fiber module of the second embodiment is the optical fiber module in which a planar lightwave circuit component 30 is connected to optical fiber arrays 1 (1a and 1b) with an adhesive 50. FIG. 7 illustrates the configuration of connecting the planar lightwave circuit component 30 to the optical fiber array 1 (1a) in the optical fiber module in the state before connected.

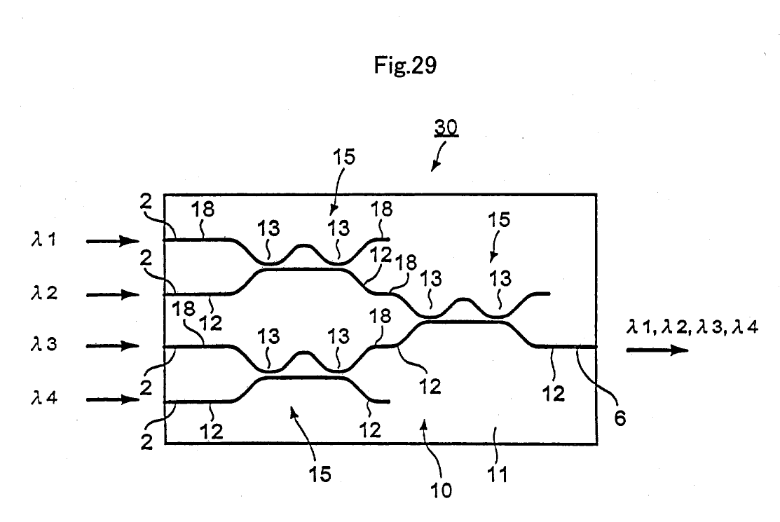

In the optical fiber module of the second embodiment, the planar lightwave circuit component 30 has a planar lightwave circuit 10 that the number of stages of the Mach-Zehnder interferometer circuits 15 is one stage greater than that of the circuit connecting the Mach-Zehnder interferometer circuits 15 in multiple stages shown in FIG. 29.

FIG. 7 omits the detailed configuration of the planar lightwave circuit 10. However, the planar lightwave circuit component 30 adapted to the second embodiment has a circuit in which the Mach-Zehnder interferometer circuits 15 are connected to the separate input optical waveguides 2 shown in FIG. 29 and the light of eight wavelengths different from each other can be multiplexed.

In the optical fiber module of the second embodiment, the configuration of connecting the planar lightwave circuit component 30 to the optical fiber array 1 (1b) is the same as that of the first embodiment.

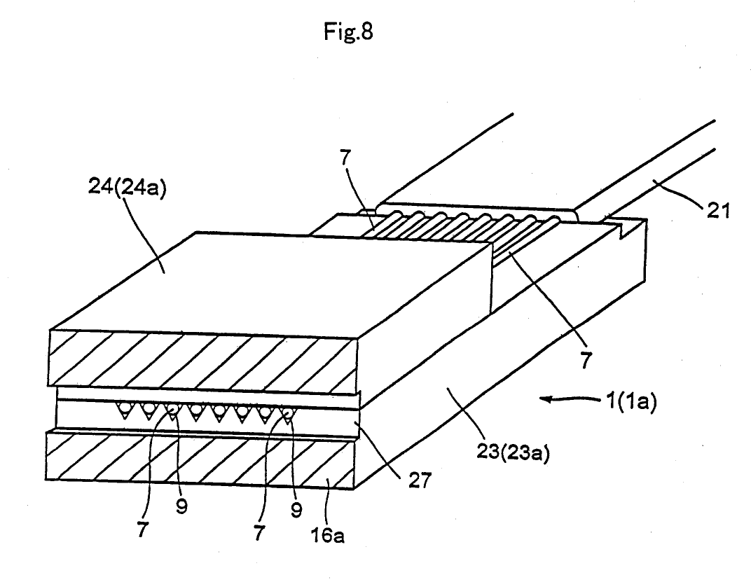

In addition, in the optical fiber module of the second embodiment, the optical fiber array 1 (1a) is abutted against the planar lightwave circuit component 30 at the alignment position, and in this state, they are fixed with the adhesive 50. The flow rate of the adhesive 50 is adjusted, whereby the adhesive 50 is applied in the shaded areas in FIG. 8, the adhesive 50 is suppressed to flow into the light transmitting area, and the no adhesive filled part 8 is formed.

Furthermore, as shown in FIGS. 7 and 8, in the second embodiment, a recess 27 is formed in a no adhesive filled part 8 in a connection end face 16a of the optical fiber array 1 (1a), and the depth of the recess 27 is about 20 μm.

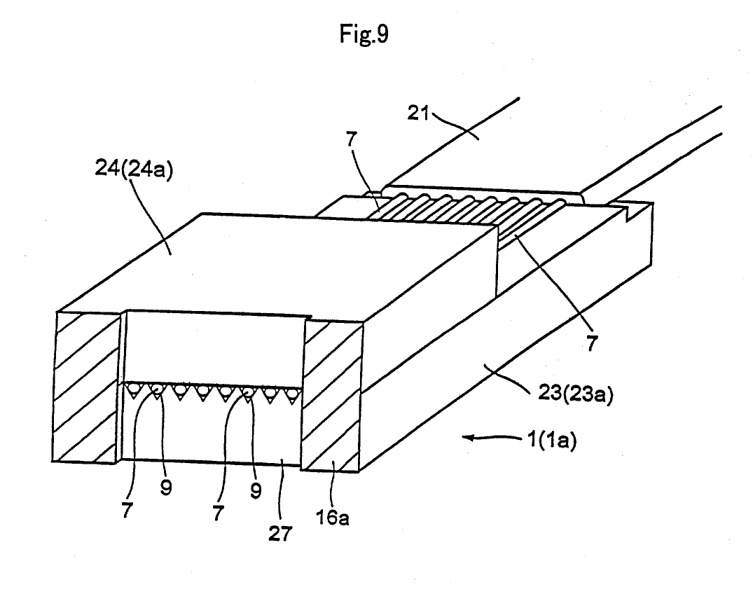

Moreover, the form, size and depth of the recess 27 are not limited particularly. For example, it is fine that the recess 27 shown in FIG. 9 is formed and the adhesive 50 is applied in the shaded areas in FIG. 9. Besides, it is acceptable to make the form that an area surrounding the light transmitting area (the area to arrange optical fibers 7) is left and the light transmitting area is recessed. The recess 27 can be formed into various shapes.

Also in the second embodiment, the planar lightwave circuit component 30 and the optical fiber arrays 1 (1a and 1b) are housed in a package 1 (not shown) where silicon oil to be a refractive index matching agent is filled. Then, the silicon oil is filled in the no adhesive filled part 8.

The optical fiber module of the second embodiment is configured as described above. The optical fiber module of the second embodiment can exert the same advantages as the first embodiment. In addition, it is fine that the silicon oil is not used in the optical fiber module of the second embodiment as similar to the first embodiment.

Then, the optical fiber module of the second embodiment can realize a highly reliable optical fiber module that has no deterioration of the adhesive 50 in the connecting parts and is stable against high intensity light even though the light intensity of the laser diode used for the pumping light source exceeds 300 mW.

Besides, in the optical fiber module of the second embodiment, the recess 27 is formed in the no adhesive filled part 8, and the formation of the recess 27 allows suppression of the adhesive to be filled in the light transmitting area. Thus, the no adhesive filled part 8 can be formed surely, and the advantages can be exerted with a simple configuration.

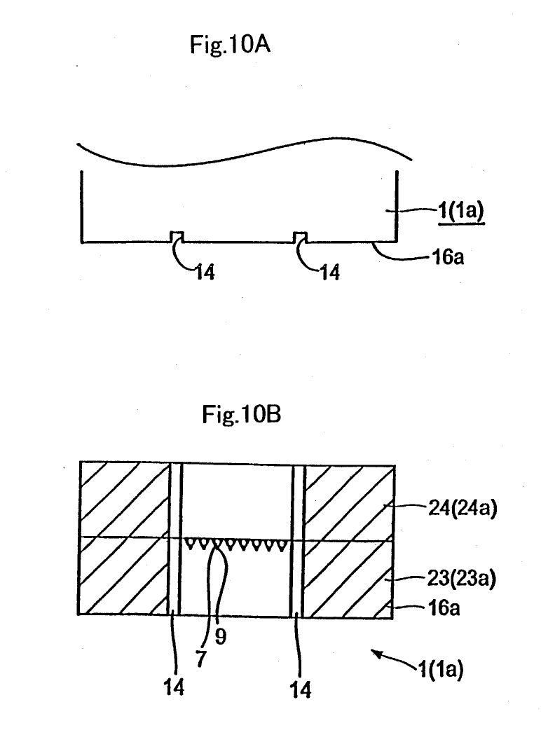

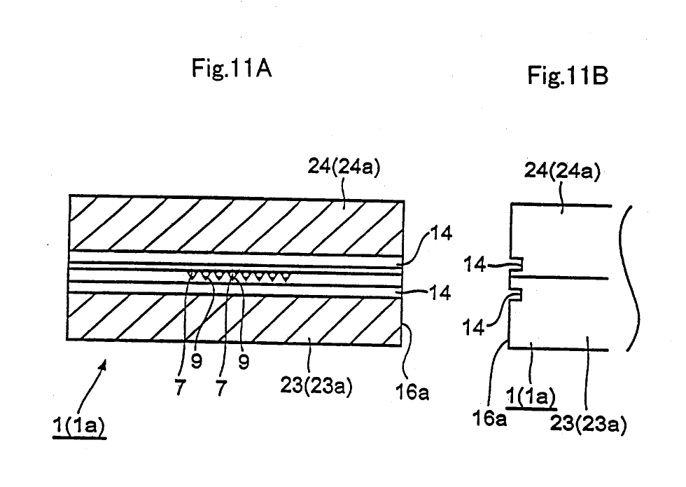

Moreover, the optical fiber module of the invention is not limited to the embodiments, which can adopt various forms. For example, the optical fiber module of the second embodiment was formed in which the recess 27 was disposed in the connection end face 16a of the optical fiber array 1 (1a) However, it is fine that grooves 14 for suppressing the adhesive 50 to be filled into the light-transmitting area are formed in the connection end face 16a of the optical fiber array 1 (1a) as shown in FIGS. 10A, 10B, 11A and 11B.

In these cases, an adhesive 50 is applied in the shaded areas shown in FIGS. 10B and 11A. In addition, when the optical fiber array 1 (1a) is connected to a connection end face 26a of the planar lightwave circuit component 30 with the adhesive 50, the same advantages can be exerted as the second embodiment. Thus, a highly reliable optical fiber module can be realized.

Furthermore, the optical fiber modules of the embodiments were formed to dispose the grooves 14 or the recess 27 in the connection end faces 16a and 16b of the optical fiber arrays 1 (1a and 1b). However, it is fine to dispose the grooves 14 or the recess 27 in the connection end faces 26a and 26b of the planar lightwave circuit component 30. In addition, it is acceptable to form the grooves 14 or the recess 27 both in the connection end faces 16a and 16b of the optical fiber arrays 1 (1a and 1b) and in the connection end faces 26a and 26b of the planar lightwave circuit component 30.

When the grooves 14 or the recess 27 are disposed in the connection end faces 16a and 16b of the optical fiber arrays 1 (1a and 1b) and the connection end faces 26a and 26b of the planar lightwave circuit component 30, it is acceptable to dispose either the grooves 14 or the recess 27, or both. Furthermore, work is further facilitated when the grooves 14 or the recess 27 are formed in the connection end faces 16a and 16b of the optical fiber array 1 (1a and 1b).

Furthermore, in the optical fiber module of the first embodiment, the grooves 14 were formed into a rectangle by the dicing saw, but the shape of the grooves 14 is not limited particularly, which is set properly. More specifically, it is fine that the grooves 14 are such grooves that can suppress the adhesive 50 to flow into the light transmitting area by the capillary action. The grooves can be formed into various shapes including a U-shape and a V-shape. The depth and size of the grooves 14 are not limited, which are set properly.

Moreover, in the optical fiber module of the embodiments, the adhesive 50 having a viscosity of about 10000 cps or under was adapted. However, the adhesive 50 is not necessarily limited to that having a viscosity of about 10000 cps.

In this case, the adhesive 50 is not allowed to flow into the clearance between the connection end faces of the optical components by utilizing the capillary action as the optical fiber module of the first embodiment, for example. However, in this case, it is acceptable that the adhesive 50 is applied to the connection end face of the optical component except the no adhesive filled part 8 beforehand and then the optical components are bonded to each other. This method can be applied to the case of using an adhesive of low viscosity as well.

Besides, the optical fiber arrays 1 (1a and 1b) adapted to the optical fiber modules of the embodiments was configured to have the guide substrates 23 (23a and 23b) and the retainer plates 24 (24a and 24b). However, the configuration of the optical fiber arrays 1 (1a and 1b) is not limited particularly, which can be set properly. For example, it is possible that the optical fiber 7 is inserted and fixed to an optical fiber ferrule formed with an insertion hole of the optical fiber 7 to form an optical fiber array.

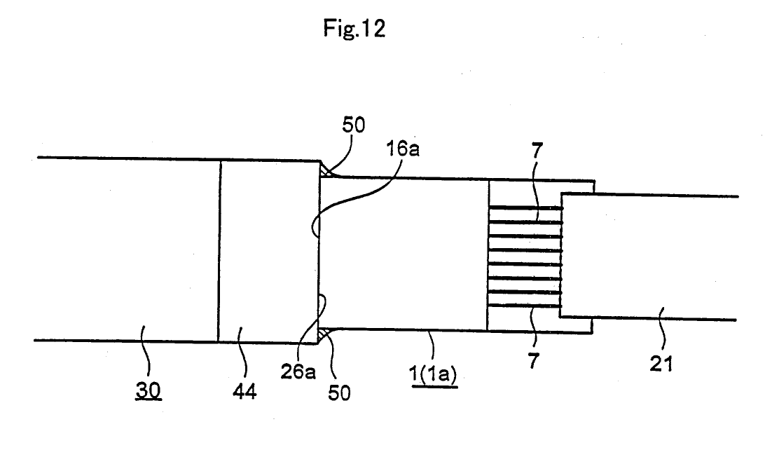

In the embodiments, the grooves 14 or the recess 27 were formed in the connection end faces 16a and 16b of the optical fiber arrays 1 (1a and 1b). However, as shown in FIG. 12, it is acceptable that the connection end faces of the optical components such as the optical fiber arrays 1 (1a and 1b) and the planar lightwave circuit component 30 are formed into flat surfaces and the adhesive 50 is applied around the connecting part of the optical components (here, the optical fiber array 1 (1a) and the planar lightwave circuit component 30).

In the optical fiber module shown in FIG. 12, an adhesive of high viscosity is used for the adhesive 50, and thus the adhesive 50 does not flow into between the connection end faces of the optical fiber array 1 (1a) and the planar lightwave circuit component 30. On this account, the configuration shown in FIG. 12 also has the no adhesive filled part in the bonding part. Furthermore, the optical fiber array 1 (1a) is connected to the planar lightwave circuit component 30 at the alignment position.

Besides, in the embodiments, the optical component was housed in the package (not shown) filled with the silicon oil. However, the refractive index matching agent such as the silicon oil is not always filled in the package.

Moreover, in the embodiments, the silicon oil was filled in the no adhesive filled part 8, but it is fine to fill refractive index matching agents such as rubber silicon RTV and silicon gel in the no adhesive filled part 8 instead of the silicon oil.

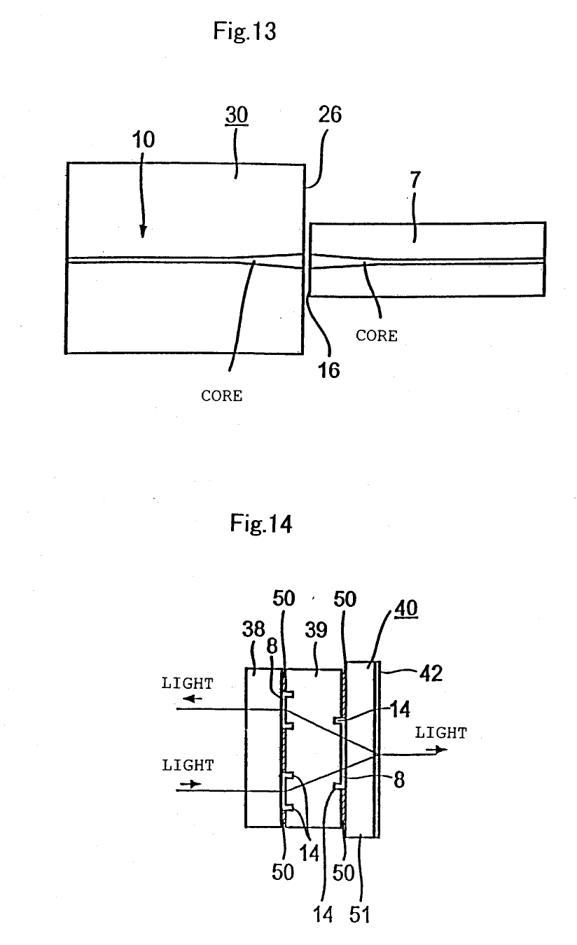

Furthermore, such the configuration is acceptable that the refractive index matching agent is not filled in the no adhesive filled part 8. In this case, when the clearance between the connection end faces of the optical components is great, there is possibility that the light emitted from the optical waveguides and the optical fibers 7 is spread to increase the connection loss. Then, for example, the configuration shown in FIG. 13 is effective.

More specifically, such the configuration is formed that the width and height of the core of the optical waveguide of the planar lightwave circuit component 30 and the core of the optical fiber 7 are slightly expanded near connection end faces 16 and 26. When this is done, the spread of the light emitted from the cores becomes small, and the cores can be connected to each other with a small loss, allowing the realization of an optical fiber module with a small loss.

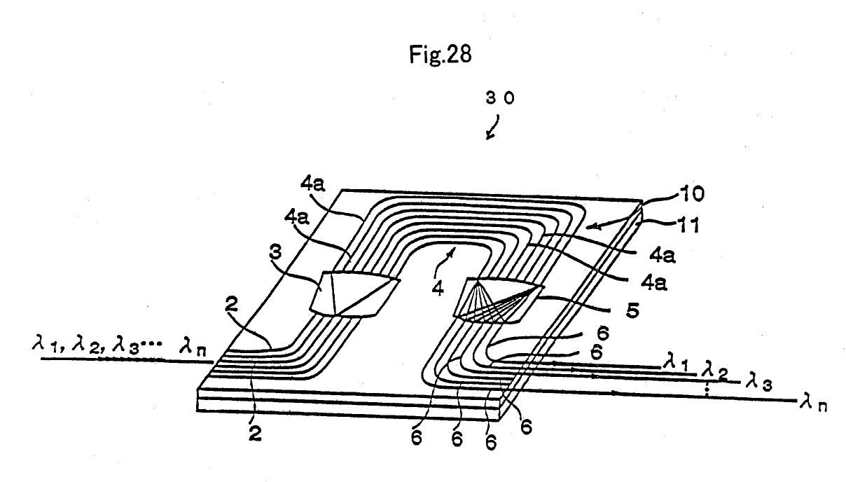

Moreover, the circuit configuration formed in the planar lightwave circuit component 30 is not limited particularly, which can be set properly. That is, the optical fiber module of the invention can form optical fiber modules by adapting various configurations as necessary, including the splitter circuit shown in FIG. 27 and the arrayed waveguide grating circuit shown in FIG. 28.

The optical components configuring the optical fiber module of the invention are not limited particularly, which can be set properly. For example, the optical components can be optical components having at least one of the dielectric multi-film filter, the optical crystal, the lens, and the prism.

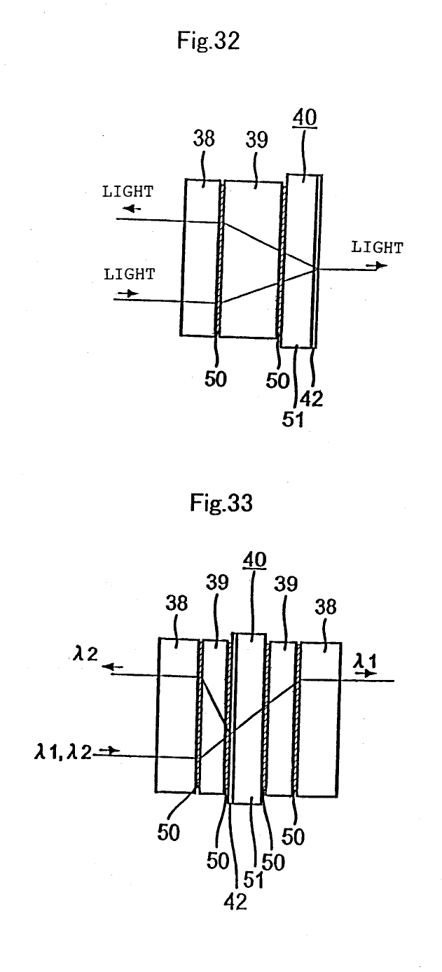

FIG. 14 illustrates an optical fiber module having a dielectric multi-film filter 40 as similar to the optical fiber module shown in FIG. 32. In the optical fiber module shown in FIG. 14, an adhesive 50 is applied in the connecting part of a sleeve 38 to a lens 39 and the connecting part of the lens 39 to the dielectric multi-film filter 40, and no adhesive filled parts 8 are disposed in the light transmitting areas. According to this, the optical fiber module shown in FIG. 14 can be assembled easily with the adhesive 50, and it can realize an excellent optical fiber module with the performance of enduring high intensity light.

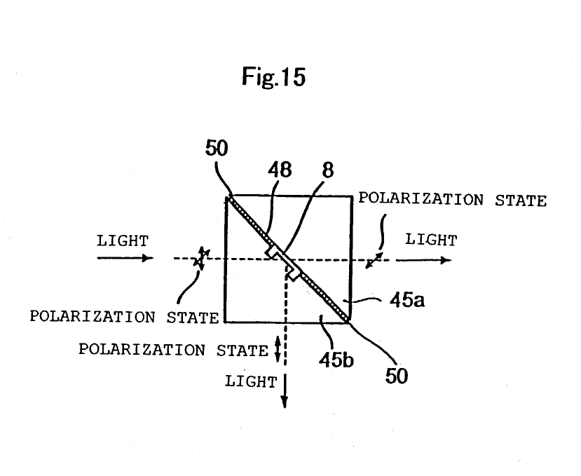

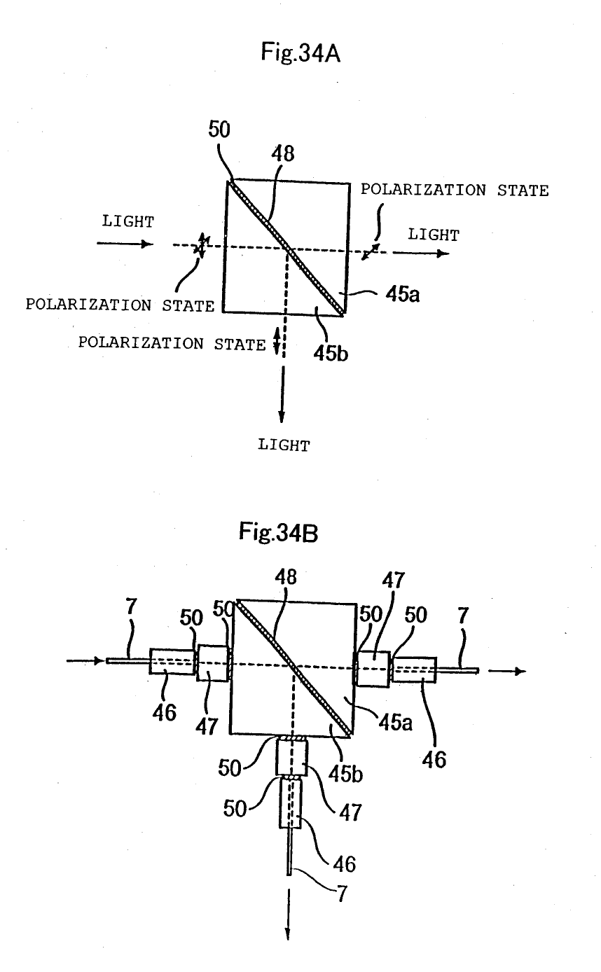

In addition to this, FIG. 15 illustrates an optical fiber module having prisms 45a and 45b as similar to the optical fiber module shown in FIG. 34. In the optical fiber module shown in FIG. 15, an adhesive 50 is applied in the connecting part of the prisms 45a and 45b and a no adhesive filled part 8 is disposed in the light transmitting area. Accordingly, the optical fiber module shown in FIG. 15 can be assembled easily with the adhesive 50, and it can realize an excellent optical fiber module having the performance of enduring high intensity light.

Furthermore, the optical fiber modules shown in FIGS. 14 and 15 are formed with the grooves 14 as shown in the first embodiment. However, the form of the grooves 14 is not necessarily formed into the forms shown in these drawings. For example, in FIG. 14, it is fine to form the grooves 14 in the sleeve 38 or dielectric multi-film filter 40. The form of the grooves 14 can be set properly.

Also in these examples, as the optical fiber modules of the first and second embodiments, when the connected optical components are immersed in the refractive index matching agent such as the silicon oil, the connection of the optical components is allowed to be lower loss.

Besides, in the embodiments, two or more of the no adhesive filled part 8 to be the light transmitting area were disposed. However, the optical fiber module of the invention can be formed to dispose the no adhesive filled part 8 in at least one of the light transmitting areas where high intensity light is passed, for example.

In the meantime, as described above, the traditional optical fiber module has a problem of increasing the connection loss due to the warp in the optical fiber array that forms the optical fiber module. In order to solve the problem, the inventor conducted the following investigations. More specifically, the inventor thought that it was important to thicken the thickness of the guide substrate corresponding to the total number of the optical fiber guide grooves in order to suppress the warp in the optical fiber array, and thus the following investigations were conducted.

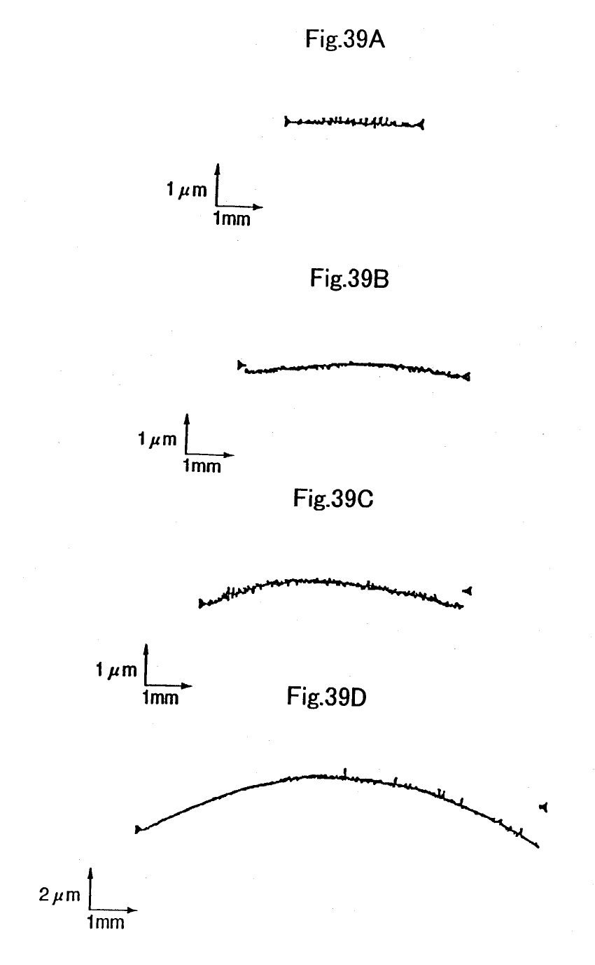

The inventor investigated the relationship between the pitch and the total number of the optical fiber guide grooves in the optical fiber array and the warp state and the warp amount of the optical fiber array in detail. The results are shown in Table 1, FIGS. 39A to 39D, 40A to 40D, and 41.

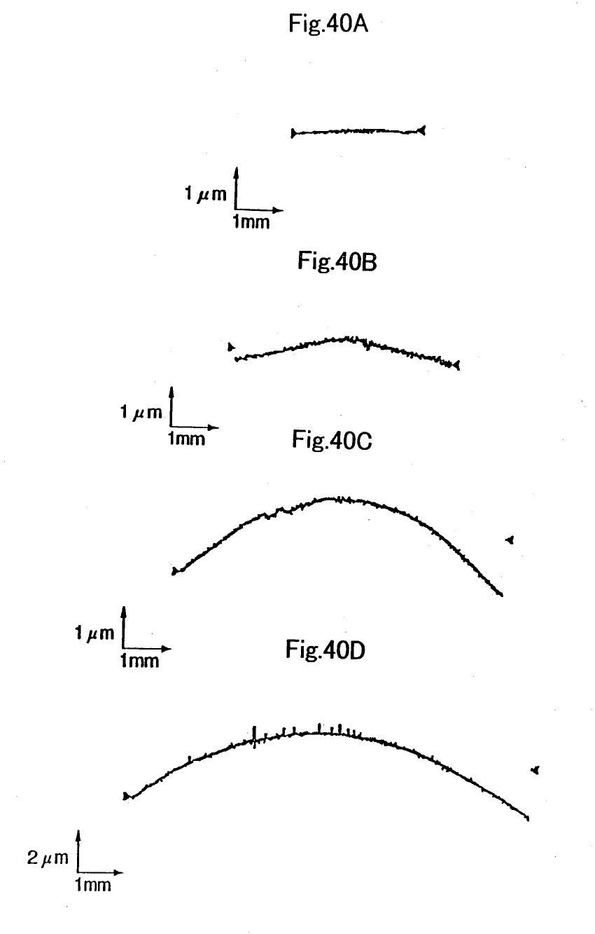

TABLE 1

| Pich of optical | Total number of | Measurement result |
|---|---|---|
| fiber guide | optical fiber | of warp in optical |
| grooves (μm) | guide grooves | fiber arrays |
| 250 | 8 | |
| 250 | 16 | |
| 250 | 20 | |
| 250 | 32 | |
| 127 | 16 | |
| 127 | 32 | |
| 127 | 48 | |
| 127 | 64 | FIG. 40D |

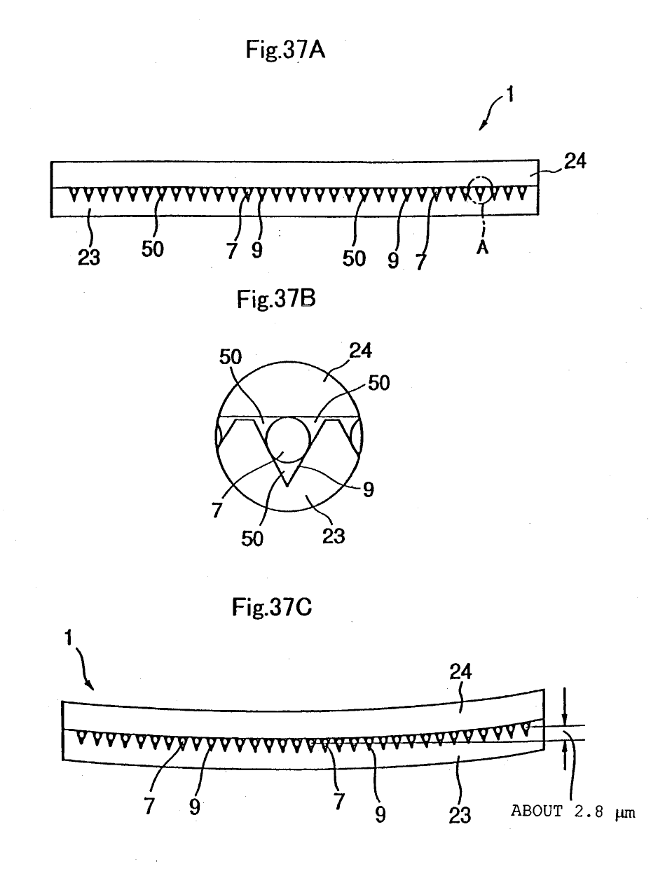

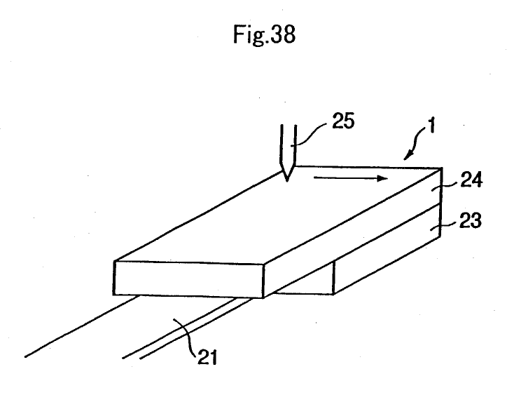

In addition, the warp amount of the optical fiber array was determined in the measuring position and direction shown in FIG. 38. In FIG. 38, 25 denotes the probe of a warp measuring machine. The results shown in Table 1, FIGS. 39A to 39D, 40A to 40D and 41 are the results of measuring the optical fiber array 1 shown in FIGS. 37A to 37C. The guide substrate 23 of the optical fiber array 1 is formed of Pyrex Glass of a thickness of 1.0 μm, and the retainer plate 24 is formed of Pyrex Glass of a thickness of 1.0 μm.

Furthermore, in conducting the investigations, the following configuration was adapted in order to avoid the interference among the optical fiber ribbons 21. More specifically, in the optical fiber array 1 where the pitch of the optical fibers 7 is 250 μm, a proper clearance was disposed at every eight fibers of the optical fibers 7 (at every eight grooves of the optical fiber guide grooves 9). In the meantime, in the optical fiber array 1 where the pitch of the optical fibers 7 is 127 μm, a proper clearance was disposed at every 16 fibers of the optical fibers 7 (at every 16 grooves of the optical fiber guide grooves 9).

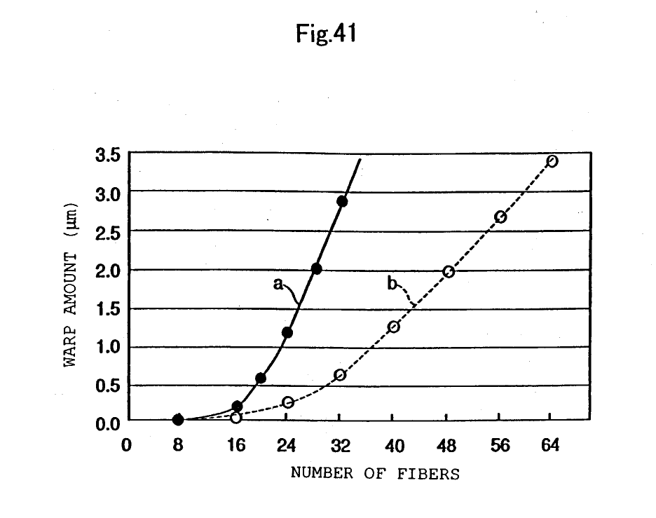

A characteristic line a shown in FIG. 41 is the measurement results that the pitch of the optical fibers 7 (the pitch of the optical fiber guide grooves 9) was set to 250 μm. A characteristic line b shown in FIG. 41 is the measurement results that the pitch of the optical fibers 7 (the pitch of the optical fiber guide grooves 9) was set to 127 μm.

According to these results, in the optical fiber array 1 where the pitch of the optical fibers 7 was set to 250 μm, the warp amount is as small as about 0.25 μm when the number of fibers is about 16 fibers. However, it was revealed that the warp amount exceeds 0.5 μm when the number of the optical fibers 7 reaches about 20 fibers or greater and the warp amount is nearly proportional to the number of the optical fibers 7 when the number of the optical fibers 7 is about 20 fibers or greater.

Moreover, in the optical fiber array 1 where the pitch of the optical fibers 7 was set to 127 μm, the warp amount is as small as about 0.25 μm when the number of fibers is about 24 fibers. However, it was revealed that the warp amount becomes 0.5 μm or grater when the number of the optical fibers 7 reaches 32 fibers or greater and the warp amount is nearly proportional to the number of the optical fibers 7 when the number of the optical fibers 7 is 32 fibers or greater.

In the following embodiments of the optical fiber array in the invention, the thickness of the guide substrate of the optical fiber array was properly formed corresponding to the pitch and the total number of the optical fiber guide grooves to be formed in the optical fiber array based on the results of the investigations. This configuration can suppress the warp in the optical fiber array even though the total number of the optical fiber guide grooves is increased (even though the number of optical fibers to be arranged is increased).

Accordingly, the optical fiber arrays shown in the following embodiments can suppress the connection loss to an optical component to be the connection counterpart such as the planar lightwave circuit component. In addition, the optical fiber arrays in the following embodiments are adapted, whereby allowing the realization of a planar lightwave circuit module with a small insertion loss capable of suppressing removal due to temperature changes.

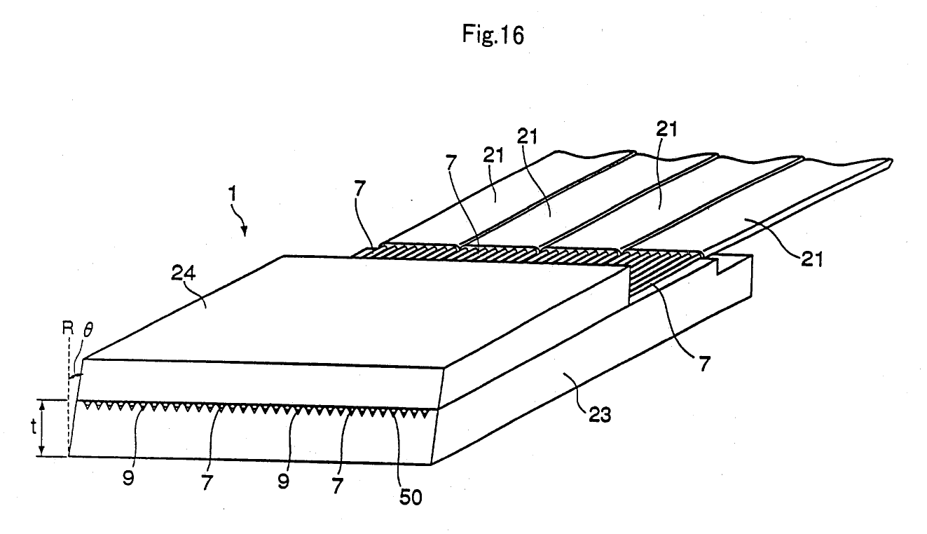

Hereafter, the first embodiment of the optical fiber array in the invention will be described. FIG. 16 typically illustrates a schematic diagram of one example (specific example) of the optical fiber array of the first embodiment.

The optical fiber array 1 of the first embodiment has a guide substrate 23 made of Pyrex Glass disposed with a plurality of optical fiber guide grooves 9 at a pitch about two times the diameter of the optical fiber 7. In addition, the optical fiber array 1 has optical fibers 7 inserted into the optical fiber guide grooves 9 in the guide substrate 23. Over the guide substrate 23, a retainer plate 24 made of Pyrex Glass having a thickness of one millimeter is placed.

The optical fiber array 1 of the first embodiment is characterized in that the total number of the optical fiber guide grooves 9 is set to 20 grooves or greater and the thickness of the guide substrate 23 (t shown in FIG. 16) is set to 1.10 mm or greater. FIG. 16 shows the optical fiber array 1 having the total number of the optical fiber guide grooves 9 being 32 grooves.

As shown in FIG. 16, in the optical fiber array 1 of the first embodiment, the connection end faces of the guide substrate 23 and the retainer plate 24 and the connection end faces of the optical fibers 7 are formed into slopes. Furthermore, it is fine to form the connection end face of the guide substrate 23 and the connection end face of the retainer plate 24 as orthogonal to the optical axis of the optical fibers 7.

The optical fiber array 1 of the first embodiment has the configuration to avoid light reflection in the connection end faces. This configuration is that the connection end faces of the guide substrate 23 and the retainer plate 24 and the connection end faces of the optical fibers 7 are formed into the slopes tilted at an angle of θ=8 degrees to the plane orthogonal to the optical axis of the optical fibers 7 (a plane formed at R in the drawing). The connection end faces of the guide substrate 23 and the retainer plate 24 and the connection end faces of the optical fibers 7 are polished slantly and formed into the slopes as described above.

In FIG. 16, the retainer plate 24 is illustrated as it contacts with the top faces of the optical fibers 7. However, the retainer plate 24 is not necessarily to contact with the top faces of the optical fibers 7. The separate optical fibers 7 are fixed to the guide substrate 23 and the retainer plate 24 with an adhesive 50.

Moreover, the preferable form of the optical fiber array 1 of the first embodiment is the optical fiber array 1 in which the thickness of the guide substrate 23 is thickened continuously or step by step as the total number of the optical fiber guide grooves 9 is increased corresponding to the total number of the optical fiber guide grooves 9.

More specifically, when the relationship between the total number of the optical fiber guide grooves 9 formed at a pitch of 250 μm and the thickness of the guide substrate 23 is determined as below, the warp amount of the guide substrate 23 can be below about 0.5 μm.

That is, for example, it is fine that the thickness of the guide substrate 23 is set to 1.10 mm or greater when the total number of the optical fiber guide grooves 9 is set to 20 grooves, and the thickness of the guide substrate 23 is set to 1.45 mm or greater when the total number of the optical fiber guide grooves 9 is set from 21 to 24 grooves. In addition, it is acceptable that the thickness of the guide substrate 23 is set to 1.73 mm or greater when the total number of the optical fiber guide grooves 9 is set from 25 to 28 grooves, and the thickness of the guide substrate 23 is set to 1.93 mm or greater when the total number of the optical fiber guide grooves 9 is set from 29 to 32 grooves.

The inventor conducted various investigations on the relationship between the total number of the optical fiber guide grooves 9 and the thickness of the guide substrate 23. The details will be described later.

The optical fiber array 1 of the first embodiment is formed as described above. A sample fabrication 1 and a sample fabrication 2 having the configuration of the embodiment were fabricated, and the warp amounts were measured. As shown in FIG. 16, the total number of the optical fiber guide grooves 9 was set to 32 grooves in the sample fabrications 1 and 2. Then, the thickness t of the guide substrate 23 was set to 1.5 mm in the sample fabrication 1, and the thickness t of the guide substrate 23 was set to 2.0 mm in the sample fabrication 2.

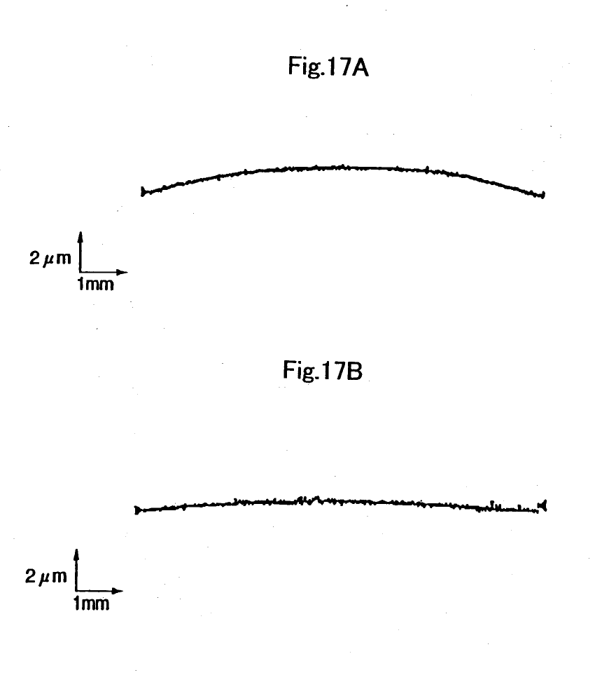

Consequently, the measurement result of the warp in an optical fiber array 1 of the sample fabrication 1 was the result shown in FIG. 17A, and the measurement result of the warp in an optical fiber array 1 of the sample fabrication 2 was the result shown in FIG. 17B.

As shown in FIGS. 17A and 17B, the warp amount of the sample fabrication 1 is about 1.2 μm, and the warp amount of the sample fabrication 2 is about 0.4 μm, being smaller. As compared with a warp amount of 2.8 μm in the traditional example, the warp amount is significantly small.

More specifically, in the optical fiber array 1 of the first embodiment, even though the total number of optical fiber guide grooves 9 arranged at a pitch of 250 μm is set to 20 or greater, the thickness of the guide substrate 23 is set to 1.10 mm or greater, and consequently the warp in the guide substrate 23 can be suppressed.

Accordingly, the optical fiber array 1 of the first embodiment can realize an excellent optical fiber array 1 capable of suppressing the offset between the optical fibers 7 and the optical component to be the connection counterpart due to the warp in the guide substrate 23 and connecting the optical component to be the connection counterpart at low loss. Then, the optical fiber array 1 of the first embodiment can suppress the offset to the optical waveguides when the optical component to be the connection counterpart is the planar lightwave circuit component 30, for example. Thus, it can realize an optical fiber module with small connection loss.

In the meantime, the inventor conducted the following investigations in order to determine the configuration of the optical fiber array 1 of the first embodiment (that is, in order to determine the relationship between the total number of the optical fiber guide grooves 9 and the preferable thickness of the guide substrate 23). Hereafter, the results of the investigations will be described.

The inventor investigated sample fabrications and comparative examples having the parameters shown in Table 2, and then the inventor determined the warp amounts of them.

TABLE 2

| | Total | Thickness | |
|---|---|---|---|
| | number of | of guide | |
| | optical fiber | substrates | Warp |
| | guide grooves | (mm) | amount (μm) |
| Sample fabrication 3 | 24 | 1.5 | About 0.5 |
| Sample fabrication 4 | 24 | 2.0 | About 0.17 |
| Comparative example 1 | 24 | 1.0 | About 1.15 |
| Sample fabrication 5 | 28 | 1.5 | About 0.8 |
| Sample fabrication 6 | 28 | 2.0 | About 0.26 |
| Comparative example 2 | 28 | 1.0 | About 1.95 |

A sample fabrication 3, a sample fabrication 4 and a comparative example 1 are the optical fiber arrays 1 having the total number of the optical fiber guide grooves 9 arranged at a pitch of 250 μm being 24 grooves. A sample fabrication 5, a sample fabrication 6 and a comparative example 2 are the optical fiber arrays 1 having the total number of the optical fiber guide grooves 9 arranged at a pitch of 250 μm being 28 grooves.

The thickness t of the guide substrates 23 of the sample fabrication 3 and the sample fabrication 5 is 1.5 mm. The thickness t of the guide substrates 23 of the sample fabrication 4 and the sample fabrication 6 is 2.0 mm. The thickness t of the guide substrates 23 of the comparative example 1 and the comparative example 2 is 1.0 mm.

As apparent from Table 2, those having a thicker guide substrate 23 have a small warp amount of the optical fiber array 1. Then, also in those having the total number of the optical fiber guide grooves 9 being 24 grooves and in those being 28 grooves, the sample fabrications have a smaller warp amount of the optical fiber array 1 than that of the comparative examples of the guide substrate 23 having a thickness of 1.0 mm.

Furthermore, the inventor determined the warp amounts of optical fiber arrays 1 where the thickness of guide substrates 23 was set to 1.0 mm, 1.5 mm and 2.0 mm in the optical fiber arrays 1 having the total number of the optical fiber guide grooves 9 being 16 grooves. The results are as shown in Table 3. In Table 3 and Tables below, a warp amount of zero indicates that the warp amount of the optical fiber array 1 was the measurement limit or below.

TABLE 3

| Total number of optical | Thickness of guide | Warp |
|---|---|---|
| fiber guide grooves | substrates (mm) | amount (μm) |
| 16 | 1.5 | About 0.1 |
| 16 | 2.0 | 0 |
| 16 | 1.0 | About 0.2 |

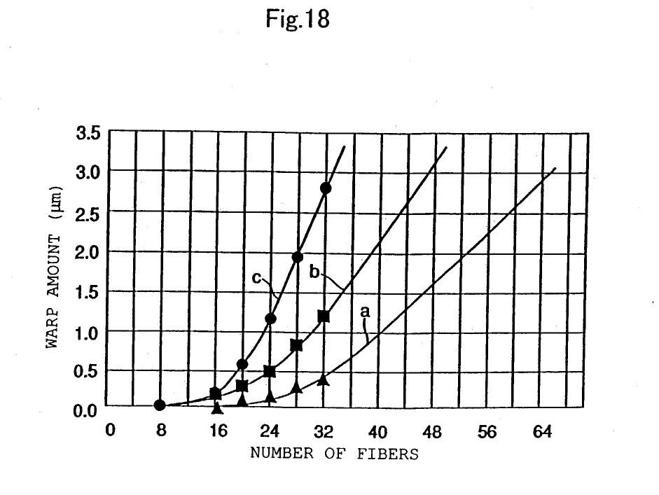

Characteristic lines a to c shown in FIG. 18 illustrate the result of summarizing the relationship between the total number of the optical fiber guide grooves 9 (the number of the optical fibers 7) and the warp amount of the optical fiber array 1. In addition to this, the characteristic line a in FIG. 18 is the relationship that the thickness of the guide substrate 23 was set to 2.0 mm. The characteristic line b in FIG. 18 is the relationship that the thickness of the guide substrate 23 was set to 1.5 mm. The characteristic line c in FIG. 18 was the relationship that the thickness of the guide substrate 23 is set to 1.0 mm.

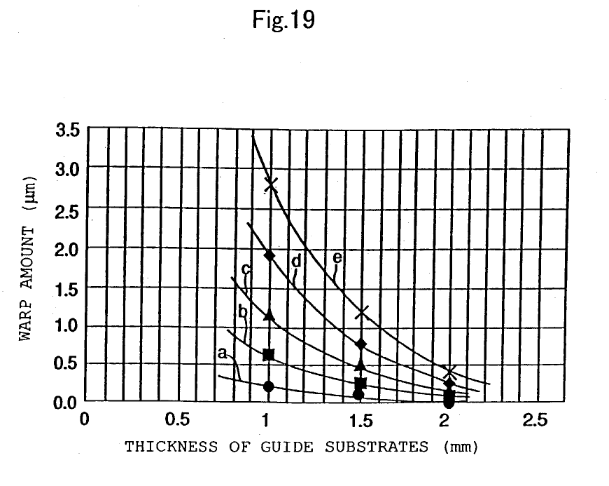

Furthermore, FIG. 19 illustrates the result of determining the relationship between the thickness of the guide substrate 23 and the warp amount at every total number of the optical fiber guide grooves 9.

A characteristic line a in FIG. 19 is the relationship that the total number of the optical fiber guide grooves 9 was set to 16 grooves. A characteristic line b in FIG. 19 is the relationship that the total number of the optical fiber guide grooves 9 was set to 20 grooves. A characteristic line c in FIG. 19 is the relationship that the total number of the optical fiber guide grooves 9 was set to 24 grooves. A characteristic line d in FIG. 19 is the relationship that the total number of the optical fiber guide grooves 9 was set to 28 grooves. A characteristic line e in FIG. 19 is the relationship that the total number of the optical fiber guide grooves 9 was set to 32 grooves.

According to the characteristic lines a to e in FIG. 19, it is revealed that the relationship between the total number of the optical fiber guide grooves 9 arranged at a pitch of 250 μm and the thickness is set as below, whereby allowing the warp amount of the optical fiber array 1 to be below 0.5 μm.

The relationship is that the thickness of the guide substrate 23 is 1.10 mm or greater when the total number of the optical fiber guide grooves 9 is set to 20 grooves, the thickness of the guide substrate 23 is 1.45 mm or greater when the total number of the optical fiber guide grooves 9 is set to 24 grooves, the thickness of the guide substrate 23 is 1.73 mm or greater when the total number of the optical fiber guide grooves 9 is set to 28 grooves, and the thickness of the guide substrate 23 is 1.93 mm or greater when the total number of the optical fiber guide grooves 9 is set to 32 grooves.

Then, in the optical fiber array 1 of the first embodiment, the thickness of the guide substrate 23 was to form thicker step by step corresponding to the total number of the optical fiber guide grooves 9, as the preferred embodiment.

More specifically, the preferred embodiment of the optical fiber array 1 of the first embodiment was that the thickness of the guide substrate 23 was 1.10 mm or greater when the total number of the optical fiber guide grooves 9 was set to 20 grooves, and the thickness of the guide substrate 23 was 1.45 mm or greater when the total number of the optical fiber guide grooves 9 was set from 21 to 24 grooves. Furthermore, the thickness of the guide substrate 23 was 1.73 mm or greater when the total number of the optical fiber guide grooves 9 was set from 25 to 28 grooves, and the thickness of the guide substrate 23 was 1.93 mm or greater when the total number of the optical fiber guide grooves 9 was set from 29 to 32 grooves.

Therefore, in the preferred embodiment, the warp amount of the optical fiber array 1 can be nearly below 0.5 μm, and consequently the connection loss to the optical component to be the connection counterpart such as the planar lightwave circuit component can be further suppressed. In addition, as the preferred embodiment, the thickness of the guide substrate 23 is increased step by step corresponding to the total number of the optical fiber guide grooves 9, whereby the thickness of the guide substrate 23 is unnecessarily increased and the optical fiber array 1 can be suppressed to be larger.

Furthermore, the optical fiber array 1 of the preferred embodiment is adapted, whereby allowing the realization of an optical fiber module with a significantly small insertion loss capable of further surely suppressing removal due to temperature changes, including a small-sized planar lightwave circuit module.

In the optical fiber array 1 of the first embodiment, the optical fibers 7 are fixed to the optical fiber guide grooves 9 with the adhesive 50, thus allowing the optical fibers 7 to be fixed in an excellent state.

Next, the second embodiment of the optical fiber array in the invention will be described. In addition, in the description of the optical fiber array of the second embodiment, the portions having the same designation as the first embodiment are designated the same numerals and signs, omitting or simplifying the overlapping description.

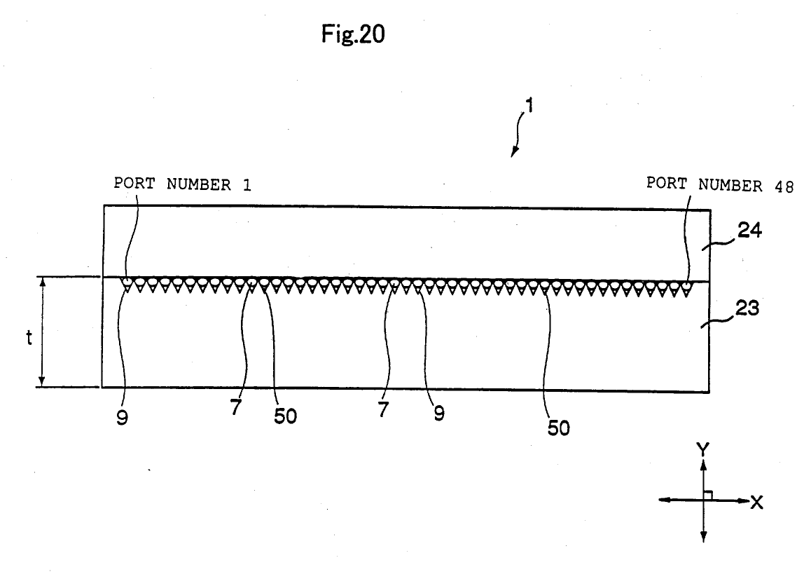

FIG. 20 typically illustrates a schematic diagram of one example of the second embodiment of the optical fiber array in the invention. Furthermore, FIG. 20 is a front view of the optical fiber array 1 seen from the connection end face.

The optical fiber array 1 of the second embodiment has a guide substrate 23 disposed with a plurality of optical fiber guide grooves 9 at an pitch nearly equal to the diameter of the optical fibers 7 and optical fibers 7 inserted into the optical fiber guide grooves 9 in the guide substrate 23.

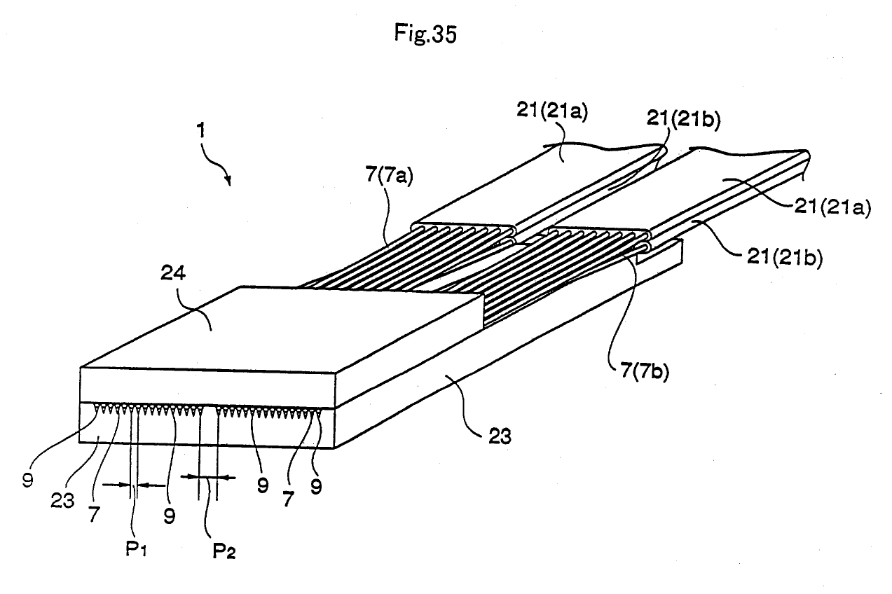

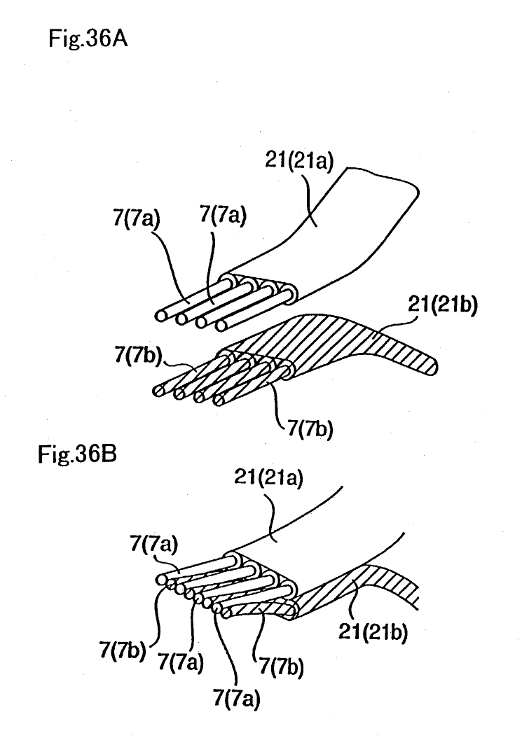

Moreover, the separate optical fibers 7 are drawn from a optical fiber ribbon 21 where eight optical fibers 7 are arranged in parallel in a row at a pitch of 250 μm, and the sheaths of the tip ends are removed and inserted into the optical fiber guide grooves 9. The optical fiber ribbons 21 are overlaid in two stages as similar to the optical fiber array 1 shown in FIG. 35, for example.

In the optical fiber array 1 of the second embodiment, the total number of the optical fiber guide grooves 9 is set to 32 grooves or greater, and the thickness of the guide substrate 23 (t shown in FIG. 20) is formed to be 1.05 mm or greater. FIG. 20 illustrates the optical fiber array 1 in which the total number of the optical fiber guide grooves 9 is 48 grooves.

Besides, the preferable form of the optical fiber array 1 of the second embodiment is the optical fiber array 1 in which the thickness of the guide substrate 23 is thickened step by step as the total number of the optical fiber guide grooves 9 is increased corresponding to the total number of the optical fiber guide grooves 9.

More specifically, when the relationship between the total number of the optical fiber guide grooves 9 formed at a pitch of 127 μm and the thickness of the guide substrate 23 is determined as below, the warp amount of the guide substrate 23 can be nearly below 0.5 μm.

That is, for example, it is acceptable that the thickness of the guide substrate 23 is 1.05 mm or greater when the total number of the optical fiber guide grooves 9 is set to 32 grooves, the thickness of the guide substrate 23 is 1.25 mm or greater when the total number of the optical fiber guide grooves 9 is set from 33 to 40 grooves, and the thickness of the guide substrate 23 is 1.47 mm or greater when the total number of the optical fiber guide grooves 9 is set from 41 to 48 grooves. Moreover, it is fine that the thickness of the guide substrate 23 is 1.85 mm or greater when the total number of the optical fiber guide grooves 9 is set from 49 to 56, and the thickness of the guide substrate 23 is 2.40 mm or greater when the total number of the optical fiber guide grooves 9 is set from 57 to 64 grooves.

In addition, the inventor conducted various investigations on the relationship between the total number of the optical fiber guide grooves 9 and the thickness of the guide substrate 23 in the optical fiber array 1 of the second embodiment, as similar to the optical fiber array 1 of the first embodiment. The details of the investigations will be described later.

The optical fiber array 1 of the second embodiment is configured as described above. For the sample fabrications, a sample fabrication 7 and a sample fabrication 8 shown below were fabricated and the warp amounts were measured. As shown in FIG. 20, in the sample fabrication 7 and 8, the total number of the optical fiber guide grooves 9 was set to 48 grooves. The thickness t of the guide substrate 23 was 1.5 mm in the sample fabrication 7, and the thickness t of the guide substrate 23 was 2.0 mm in the sample fabrication 8.

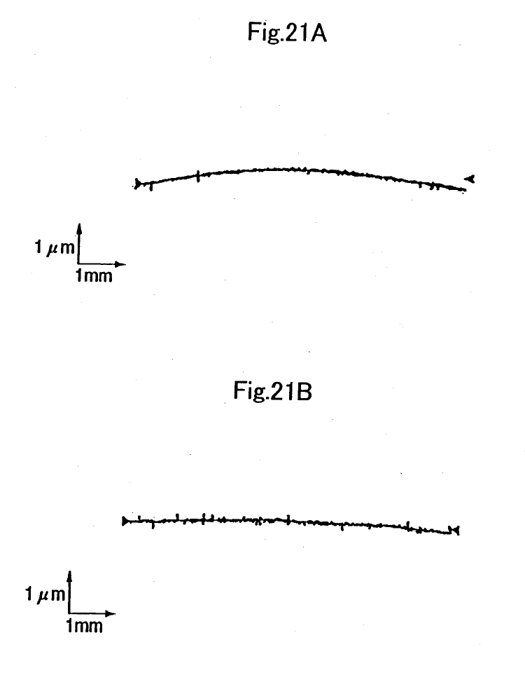

Consequently, the measurement result of the warp in the optical fiber array 1 of the sample fabrication 7 was the result shown in FIG. 21A. The measurement result of the warp in the optical fiber array 1 of the sample fabrication 8 was the result shown in FIG. 21B.

As shown in the drawings, the warp amount of the sample fabrication 7 is bout 0.45 μm, and the warp amount of the sample fabrication 8 is about 0.15 μm, being smaller. The warp amounts are significantly smaller than a warp amount of 2.0 μm in the optical fiber array of the traditional example.

More specifically, in the optical fiber array of the second embodiment, the total number of the optical fiber guide grooves 9 arranged at a pitch of 127 μm is set to 32 grooves or greater, but the thickness of the guide substrate 23 is set to 1.05 mm or greater, whereby the warp in the guide substrate 23 can be suppressed. In this manner, the optical fiber array of the second embodiment can also exert the same advantages of the optical fiber array of the first embodiment.

Furthermore, the inventor fabricated the following sample fabrications in which the total number of the optical fiber guide grooves 9 arranged at a pitch of 127 μm was set to 64 grooves, and then the inventor measured the measurement result of the warp.

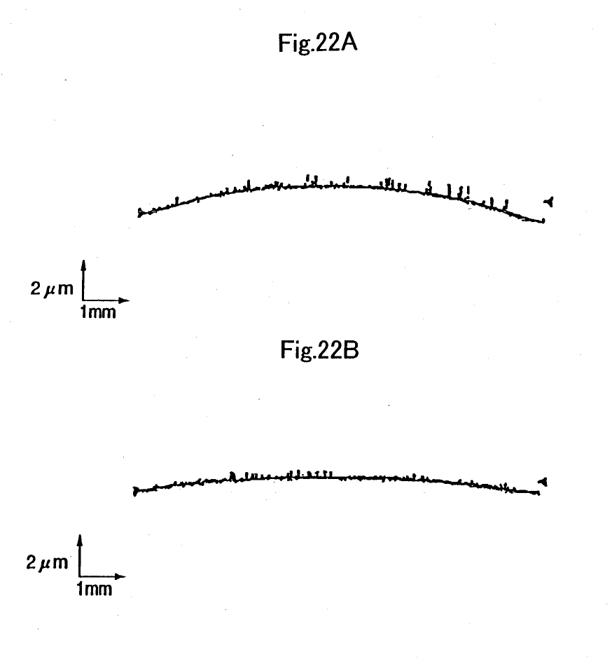

More specifically, FIG. 22A shows the measurement result of the warp in an optical fiber array 1 of the sample fabrication 9 where the thickness t of the guide substrate 23 was 1.5 mm. In addition to this, FIG. 22B shows the measurement result of the warp in an optical fiber array 1 of the sample fabrication 10 where the thickness t of the guide substrate 23 was 2.0 mm.

As shown in these drawings, the warp amount of the sample fabrication 9 is about 1.4 μm, and the warp amount of the sample fabrication 10 is about 0.7 μm, being small. It was revealed that the warp amounts are significantly smaller than a warp amount of 3.4 μm in the optical fiber array of the traditional example.

Moreover, the inventor conducted the following investigations in order to determine the relationship between the total number of the optical fiber guide grooves 9 and the preferable thickness of the guide substrate 23 in the second embodiment. Hereafter, the results of the investigations will be described.

As shown in Table 4, the inventor fabricated optical fiber arrays 1 in which the total number of the optical fiber guide grooves 9 arranged at a pitch of 127 μm was 32, 40 and 56 grooves as the sample fabrications of the optical fiber array of the second embodiment and the comparative examples.

TABLE 4

| | Total | Thickness | |
|---|---|---|---|
| | number of | of guide | |
| | optical fiber | substrates | Warp |
| | guide grooves | (mm) | amount (μm) |
| Sample fabrication 11 | 32 | 1.5 | About 0.1 |
| Sample fabrication 12 | 32 | 2.0 | 0 |
| Comparative example 3 | 32 | 1.0 | About 0.6 |
| Sample fabrication 13 | 40 | 1.5 | About 0.22 |
| Sample fabrication 14 | 40 | 2.0 | About 0.05 |
| Comparative example 4 | 40 | 1.0 | About 1.25 |
| Sample fabrication 15 | 56 | 1.5 | About 0.95 |
| Sample fabrication 16 | 56 | 2.0 | About 0.37 |
| Comparative example 5 | 56 | 1.0 | About 2.7 |

The total number of the optical fiber guide grooves 9 was set to 32 grooves in sample fabrications 11 and 12, and a comparative example 3. The total number of the optical fiber guide grooves 9 was set to 40 grooves in sample fabrication 13 and 14, and a comparative example 4. The total number of the optical fiber guide grooves 9 was set to 56 grooves in sample fabrications 15 and 16, and a comparative example 5.

The thickness t of the guide substrate 23 was set to 1.5 mm in the sample fabrications 11, 13 and 15. The thickness t of the guide substrate 23 was 2.0 mm in the sample fabrications 12, 14 and 16. The thickness t of the guide substrate 23 was set to 1.0 μm in the comparative examples 3, 4 and 5. Then, the inventor measured the warp amounts of the optical fiber arrays 1, and the inventor showed the results in Table 4.

As apparent from Table 4, those having a greater thickness of the guide substrate 23 have a smaller warp amount of the optical fiber array 1. In the optical fiber array 1 of the second embodiment, all of those having the total number of the optical fiber guide grooves 9 being 32, 40 and 56 grooves have the warp amount smaller than that of the comparative example 5 where the thickness of the guide substrate 23 is 1.0 mm.

Furthermore, the inventor determined the warp amounts of optical fiber arrays 1 in which the thickness of the guide substrate 23 was 1.0 mm, 1.5 mm and 2.0 mm, in the optical fiber array 1 of the total number of the optical fiber guide grooves 9 being 24 grooves as well. Table 5 shows the results.

TABLE 5

| Total number of optical | Thickness of guide | Warp |
|---|---|---|
| fiber guide grooves | substrates (mm) | amount (μm) |
| 24 | 1.5 | 0 |
| 24 | 2.0 | 0 |
| 24 | 1.0 | About 0.25 |

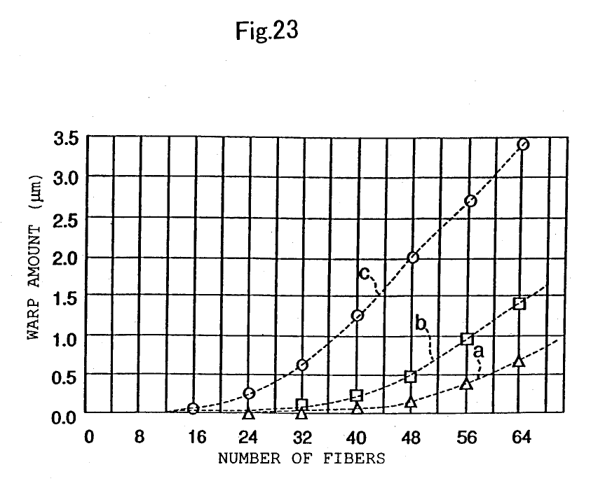

Characteristics lines a to c shown in FIG. 23 illustrate the results of the relationship between the total number of the optical fiber guide grooves 9 (the number of the optical fibers 7) and the warp amount of the optical fiber array 1. The characteristic line a shown in FIG. 23 shows the relationship that the thickness of the guide substrate 23 was set to 2.0 mm. The characteristic line b in FIG. 23 shows the relationship that the thickness of the guide substrate 23 was set to 1.5 mm. The characteristic line c in FIG. 23 shows the relationship that the thickness of the guide substrate 23 was set to 1.0 mm.

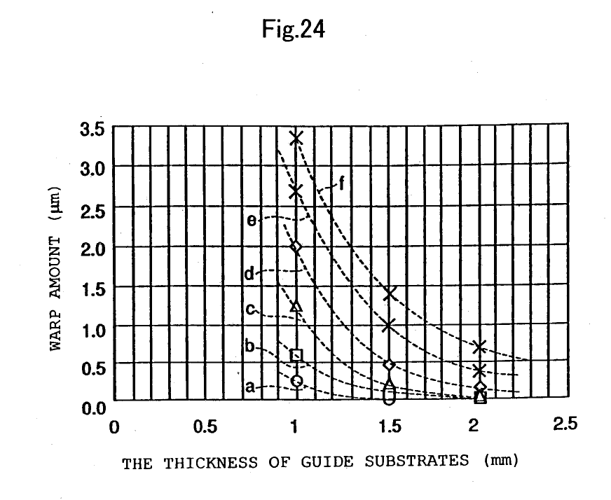

Besides, FIG. 24 shows the results of determining the relationship between the warp amount and the thickness of the guide substrate 23 at every total number of the optical fiber guide grooves 9.

In addition, a characteristic line a shown in FIG. 24 shows the relationship that the total number of the optical fiber guide grooves 9 was set to 24 grooves. A characteristic line b in FIG. 24 shows the relationship that the total number of the optical fiber guide grooves 9 was set to 32 grooves. A characteristic line c in FIG. 24 shows the relationship that the total number of the optical fiber guide grooves 9 was set to 40 grooves. A characteristic line d in FIG. 24 shows the relationship that the total number of the optical fiber guide grooves 9 was set to 48 grooves. A characteristic line e in FIG. 24 shows the relationship that the total number of the optical fiber guide grooves 9 was set to 56 grooves. A characteristic line f in FIG. 24 shows the relationship that the total number of the optical fiber guide grooves 9 was set to 64 grooves.

The characteristic lines a to f in FIG. 24 reveal the followings. More specifically, the thickness of the guide substrate 23 is 1.05 mm or greater when the total number of the optical fiber guide grooves 9 arranged at a pitch of 127 μm is set to 32 grooves, and the thickness of the guide substrate 23 is 1.25 mm or greater when the total number of the optical fiber guide grooves 9 is set to 40 grooves. Accordingly, the warp amount of the optical fiber array 1 can be nearly below 0.5 μm.

Similarly, the thickness of the guide substrate 23 is 1.47 mm or greater when the total number of the optical fiber guide grooves 9 is set to 48 grooves, the thickness of the guide substrate 23 is 1.85 mm or greater when the total number of the optical fiber guide grooves 9 is set to 56 grooves, and the thickness of the guide substrate 23 is 2.40 mm or greater when the total number of the optical fiber guide grooves 9 is set to 64 grooves. Therefore, the warp amount of the optical fiber array 1 can be nearly below 0.5 μm.

Then, as the preferred embodiment of the optical fiber array 1 of the second embodiment, the thickness of the guide substrate 23 was increased step by step corresponding to the total number of the optical fiber guide grooves 9.

That is, in the preferred embodiment of the optical fiber array 1 of the second embodiment, the thickness of the guide substrate 23 is 1.05 mm or greater when the total number of the optical fiber guide grooves 9 is set to 32 grooves, and the thickness of the guide substrate 23 is 1.25 mm or greater when the total number of the optical fiber guide grooves 9 is set from 33 to 40. Moreover, in the optical fiber array 1, the thickness of the guide substrate 23 is 1.47 mm or greater when the total number of the optical fiber guide grooves 9 is set from 41 to 48 grooves, the thickness of the guide substrate 23 is 1.85 mm or greater when the total number of the optical fiber guide grooves 9 is set from 49 to 56 grooves, and the thickness of the guide substrate 23 is 2.40 mm or greater when the total number of the optical fiber guide grooves 9 is set from 57 to 64 grooves.

Therefore, in the preferred embodiment of the optical fiber array 1 of the second embodiment, the warp amount of the optical fiber array 1 can be nearly below 0.5 μm. Accordingly, the optical fiber array 1 of the second embodiment can further suppress the connection loss to the optical component to be the connection counterpart such as the planar lightwave circuit component. Moreover, the optical fiber array 1 is adapted, whereby allowing the realization of a planar lightwave circuit module with a significantly small insertion loss capable of further suppressing removal due to temperature changes.

Next, one embodiment of the planar lightwave circuit module having the embodiment of the optical fiber array as described above will be described. This planar lightwave circuit module has a planar lightwave circuit component 30 having an arrayed waveguide grating circuit shown in FIG. 28, which is configured to dispose optical fiber arrays 1 (1a and 1b) on the out going side and the incident side of the planar lightwave circuit component 30.

The optical fiber array 1 (1b) disposed on the light incident side is formed in which a single optical fibers 7 is fixed as the optical fiber array 1(1b) disposed in the planar lightwave circuit module shown in FIG. 27, for example.

In the meantime, the optical fiber array 1 (1a) disposed on the light outgoing side is formed in which 48 grooves of the optical fiber guide grooves 9 are arranged in a guide substrate 23 at a pitch of 127 μm as similar to the sample fabrication 7 of the optical fiber array 1 of the second embodiment shown in FIG. 20. The guide substrate 23 is Pyrex Glass having a thickness of 1.5 μm.

The optical fiber array 1 (1a) is formed in which 48 fibers of the optical fibers drawn from six ribbons of eight-core optical fiber ribbons 21 are inserted into the corresponding optical fiber guide grooves 9 of the guide substrate 23. The optical fibers 7 are held by a retainer plate 24 made of Pyrex Glass having a thickness of 1.0 μm. The separate optical fibers 7 are fixed to the optical fiber guide grooves 9 with an adhesive 50.

In fabricating the planar lightwave circuit module, the optical fiber array 1 (1b) on the incident side and the planar lightwave circuit component 30 were placed on a positioning device, and light was allowed to enter from the optical fibers 7 of the optical fiber array 1 (1b). In this state, the light was passed through 24 fibers of the odd numbered optical fibers 7 arranged in the optical fiber array 1 (1a) on the outgoing side.

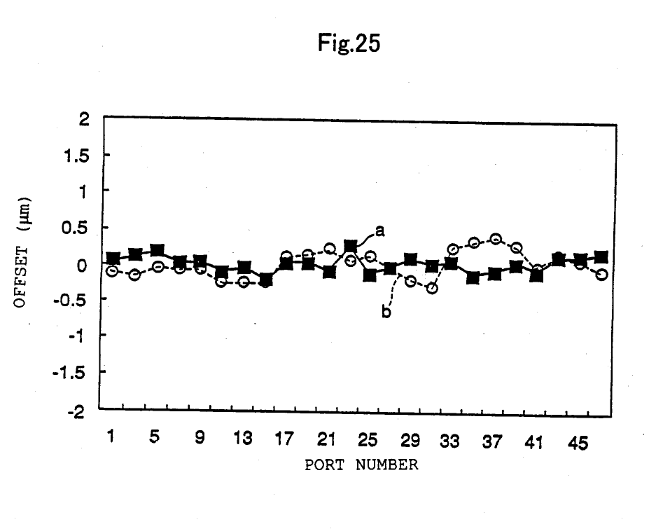

In addition, the separate optical fibers 7 were positioned and aligned with the output optical waveguides 6 of the planar lightwave circuit component 30 such that the average offset amount of them became the minimum, and then the results shown in FIG. 25 were obtained. Moreover, a characteristic line b in FIG. 25 shows the separate offset amounts in the X-axis direction shown in FIG. 20. A characteristic line a shown in FIG. 25 shows them in the Y-axis direction shown in FIG. 20. The port numbers shown in FIG. 25 are numbered from the left side shown in FIG. 20 one by one.

As apparent from the characteristic line a shown in FIG. 25, the shift amount in the Y-axis direction was about 0.3 μm at the maximum, being excellent. This is because the warp amount of the optical fiber array 1 is as small as 0.45 μm. As shown in the characteristic line b in FIG. 25, the offset in the X-axis direction is about 0.4 μm at the maximum. Thus, the maximum value of the connection loss caused by the offset can be estimated to be 0.1 dB or below.

Furthermore, six of the planar lightwave circuit modules in the embodiment were fabricated, and the temperature cycling test from −40 to 85° C. was conducted for 1000 cycles with three planar lightwave circuit modules among them. The damp heat test at a temperature of 85° C. and a humidity of 85% was conducted for 5000 hours with the remaining three planar light wave circuit modules. Consequently, the variation in the insertion loss of the planar lightwave circuit modules was 0.25 dB at the maximum, and excellent results were obtained.

As described above, the planar lightwave circuit module of the embodiment could realize an excellent planar lightwave circuit module with a small connection loss of the optical fiber array 1 (1a and 1b) to the planar lightwave circuit component 30 and with small variations in the insertion loss even though under severe environments where temperatures and humidities vary greatly.

In addition, the optical fiber array of the invention and the planar lightwave circuit module with the optical fiber array are not limited to the embodiments, which can be adopted various forms. For example, in the first embodiment of the optical fiber array 1, the sample fabrications were described in which the total number of the optical fiber guide grooves 9 was set to 20, 24, 28 and 32 grooves. In the second embodiment, the sample fabrications were described in which the total number of the optical fiber guide grooves 9 was set to 32, 40, 48, 56 and 64 grooves. However, the total number of the optical fiber guide grooves 9 is not limited particularly, which can be set properly.

More specifically, as the optical fiber arrays 1 in the embodiments, both in those having the pitch of the optical fiber guide grooves 9 being 250 μm and in those having the pitch of 127 μm, the following configuration is adapted. Consequently, the warp in the optical fiber array 1 can be suppressed, and the connection loss of the planar lightwave circuit component 30 can be reduced. This configuration is that the thickness of the guide substrate is thickened continuously or step by step as the total number of the optical fiber guide grooves 9 is increased corresponding to the total number of the optical fiber guide grooves 9.

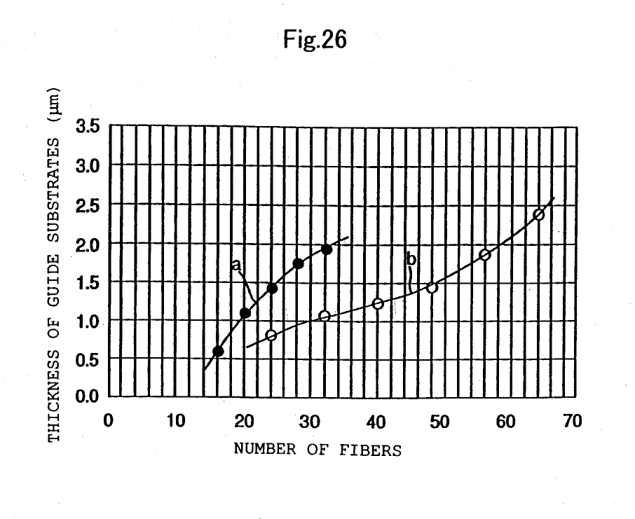

For example, when the optical fiber array 1 is formed of the guide substrate 23 and the retainer plate 24 made of Pyrex Glass, the thickness of the guide substrate 23 is determined based on characteristic lines a and b shown in FIG. 26. Therefore, the warp amount of the optical fiber array 1 can be nearly below 0.5 μm. In FIG. 26, the optical fiber arrays 1 were fabricated based on the sample fabrications of the optical fiber arrays 1 of the first and second embodiments. The characteristic line a shows the characteristics of a pitch of 250 μm, and the characteristic line b shows those of a pitch of 127 μm.

Preferably, the warp amount of the optical fiber array 1 is below 0.5 μm. However, it is acceptable that warp amounts other than this are determined, characteristics data as shown in FIG. 26 is sought for the determined warp amounts, and the relationship between the total number of the optical fiber guide grooves 9 and the thickness of the guide substrate 23 is determined based on the characteristics data.

In determining the thickness of the guide substrate 23, it is fine that the thickness is determined thicker in expectation of the fabrication errors and then the optical fiber array 1 is fabricated.

In the embodiments, the guide substrate 23 and the retainer plate 24 of the optical fiber array 1 were formed of Pyrex Glass. However, the materials of the guide substrate 23 and the retainer plate 24 are not limited particularly, which can be set properly. For example, it is acceptable to form them of silicon.

In the embodiments, the thickness of the retainer plate 24 of the optical fiber array 1 was set to 1.0 mm. However, the thickness of the retainer plate 24 is not limited to 1.0 mm, which can be set properly.

In the optical fiber array 1 of the first embodiment, the pitch of the optical fiber guide grooves 9 was set to 250 μm. However, when the pitch of the optical fiber guide grooves 9 is formed to be about twice the diameter of the optical fiber 7, it is fine to set the pitch of the optical fiber guide grooves 9 slightly greater or smaller than 250 μm.

In the optical fiber array 1 of the second embodiment, the pitch of the optical fiber guide grooves 9 was set to 127 μm. However, when the pitch of the optical fiber guide grooves 9 is formed to be nearly equal to the diameter of the optical fiber 7, it is acceptable to set the pitch of the optical fiber guide grooves 9 to 125 μm or 126 μm, for example.

What is claimed as new and is desired to be secured by Letters Patent of the United States is:

1. An optical fiber module comprising:
at least one bonding part connecting optical components with an adhesive, the optical components having connection end faces faced to each other,
wherein at least one of the bonding parts has a no adhesive filled part where the adhesive is not applied in a light transmitting area.

2. The optical fiber module according to claim 1, wherein a groove for suppressing the adhesive to be filled into the light transmitting area is formed in a periphery of the no adhesive filled part in at least one connection end face of the optical components.

3. The optical fiber module according to claim 1, wherein a recess is formed in the no adhesive filled part in at least one connection end face of the optical components.

4. The optical fiber module according to claim 1, wherein a refractive index matching agent is filled in at least one of the no adhesive filled parts.

5. The optical fiber module according to claim 1, wherein the optical components connected by the bonding part is housed in a package, and a refractive index matching agent is filled in the package.

6. The optical fiber module according to claim 4, wherein the refractive index matching agent has a main component of silicon.

7. The optical fiber module according to claim 6, wherein the refractive index matching agent is silicon oil.

8. The optical fiber module according to claim 1, wherein in the optical components connected by a bonding art having the no adhesive filled part, at least one of them is a planar lightwave circuit component, and at least one of them is an optical fiber array.

9. The optical fiber module according to claim 8, wherein a groove for suppressing the adhesive to be filled into the light transmitting area is formed in a connection end face of the optical fiber array.

10. The optical fiber module according to claim 1, wherein the optical components connected by a bonding part having the no adhesive filled part has at least one of a dielectric multi-film filter, an optical crystal, a lens, and a prism.

11. The optical fiber module according to claim 1, wherein the adhesive has a viscosity of 10000 cps or below.

12. A method for fabricating the optical fiber module according to claim 1 comprising:
pouring an adhesive into an area except a no adhesive filled part in a bonding part of optical components in a state of abutting connection end faces of the optical components to be connected; and
curing the adhesive to fix the optical components each other.

13. An optical fiber array comprising:
a guide substrate having a plurality of optical fiber guide grooves arranged at a pitch nearly twice a diameter of an optical fiber; and
optical fibers inserted into the optical fiber guide grooves in the guide substrate, wherein a total number of the optical fiber grooves is 20 grooves or greater, and a thickness of the guide substrate is 1.10 mm or greater.

14. The optical fiber array according to claim 14, wherein the thickness of the guide substrate is thickened continuously or step by step as the total number of the optical fiber guide grooves is increased corresponding to the total number of the optical fiber guide grooves.

15. The optical fiber array according to claim 14, wherein the thickness of the guide substrate is formed to be 1.10 mm or greater when the total number of the optical fiber guide grooves is set to 20 grooves,
the thickness of the guide substrate is formed to be 1.45 mm or greater when the total number of the optical fiber guide grooves is set from 21 to 24 grooves,
the thickness of the guide substrate is formed to be 1.73 mm or greater when the total number of the optical fiber guide grooves is set from 25 to 28 groves, and
the thickness of the guide substrate is formed to be 1.93 mm or greater when the total number of the optical fiber guide grooves is set from 29 to 32 grooves.

16. An optical fiber array comprising:
a guide substrate having a plurality of optical fiber guide grooves arranged at a pitch nearly equal to a diameter of an optical fiber; and
optical fibers inserted into the optical fiber guide grooves in the guide substrate,
wherein a total number of the optical fiber guide grooves is 32 grooves or greater, and
a thickness of the guide substrate is 1.05 mm or greater.

17. The optical fiber array according to claim 16, wherein the thickness of the guide substrate is thickened continuously or step by step as the total number of the optical fiber guide grooves is increased corresponding to the total number of the optical fiber guide grooves.

18. The optical fiber array according to claim 17, wherein the thickness of the guide substrate is formed to be 1.05 mm or greater when the total number of the optical fiber guide grooves is set to 32 grooves,
the thickness of the guide substrate is formed to be 1.25 mm or greater when the total number of the optical fiber guide grooves is set from 33 to 40 grooves,
the thickness of the guide substrate is formed to be 1.47 mm or greater when the total number of the optical fiber guide grooves is set from 41 to 48 grooves,
the thickness of the guide substrate is formed to be 1.85 mm or greater when the total number of the optical fiber guide grooves is set from 49 to 56 grooves, and
the thickness of the guide substrate is formed to be 2.40 mm or greater when the total number of the optical fiber guide grooves is set from 57 to 64 grooves.

19. The optical fiber array according to claim 13, wherein the optical fibers are fixed to the optical fiber guide grooves with an adhesive.

20. The optical fiber array according to claim 16, wherein the optical fibers are fixed to the optical fiber guide grooves with an adhesive.

21. The optical fiber array according to claim 13, wherein a warp amount of the optical fiber array is 0.5 μm or below.

22. The optical fiber array according to claim 16, wherein a warp amount of the optical fiber array is 0.5 μm or below.

23. A planar lightwave circuit module comprising:
the optical fiber array according to claim 13.

24. A planar lightwave circuit module comprising:
the optical fiber array according to claim 16.
